(19) United States
(12) Patent Application Publication
(10) Pub. No.: US 2023/0118780 A1
(43) Pub. Date: Apr. 20, 2023

(54) ACCURACY OF POSITIONING TECHNIQUES IN FULL DUPLEX MODE

(71) Applicant: QUALCOMM Incorporated, San Diego, CA (US)

(72) Inventors: Ahmed Attia ABOTABL, San Diego, CA (US); Alexandros MANOLAKOS, Escondido, CA (US); Muhammad Sayed Khairy ABDELGHAFFAR, San Jose, CA (US)

(21) Appl. No.: 17/915,175

(22) PCT Filed: Apr. 9, 2021
(86) PCT No.: PCT/US2021/026594

§ 371 Date: Sep. 28, 2022

(30) Foreign Application Priority Data
May 12, 2020 (GR) 20200100245

(51) Int. Cl. G01S 5/00; H04L 5/00; H04L 5/14

(52) U.S. Cl. CPC G01S 5/0063; H04L 5/14; H04L 5/0051

(57) ABSTRACT

Techniques are provided for utilizing positioning reference signals (PRS) in full duplex scenarios. An example method of providing positioning information for a mobile device to a base station includes receiving, at the mobile device, a positioning request and an accuracy requirement from the base station, determining one or more positioning reference signal transmissions based on the accuracy requirement, obtaining position measurement information based on the one or more positioning reference signal transmissions, and providing the position measurement information to the base station.

### BACKGROUND

### Field of the Disclosure

Aspects of the present disclosure relate to wireless communications, and more particularly, to techniques for user equipment(s) to utilize positioning reference signal with full duplex operations.

### Description of Related Art

Wireless communication systems are widely deployed to provide various telecommunication services such as telephony, video, data, messaging, broadcasts, positioning, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Fifth Generation New Radio systems (5G NR), Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

Obtaining the location or position of a mobile device that is accessing a wireless communication system may be useful for many applications including, for example, emergency calls, personal navigation, asset tracking, locating a friend or family member, etc. Existing position methods include methods based on measuring radio signals transmitted from a variety of devices including satellite vehicles (SVs) and terrestrial radio sources in a wireless network such as base stations and access points. In methods based on terrestrial radio sources, a mobile device may measure the timing of signals received from two or more base stations and determine times of arrival, time differences of arrival and/or receive time-transmit time differences. Combining these measurements with known locations for the base stations and known transmission times from each base station may enable location of the mobile device using such position methods as Observed Time Difference Of Arrival (OTDOA) or Enhanced Cell ID (ECID).

To further help location determination (e.g. for OTDOA), Positioning Reference Signals (PRS) may be transmitted by base stations in order to increase both measurement accuracy and the number of different base stations for which timing measurements can be obtained by a mobile device. In general, the base stations and mobile devices may communicate using half duplex operation which sequentially utilize either downlink channels (e.g., for transmissions from a base station to a mobile device) or uplink channels (e.g., for transmissions from a mobile device to a base station). Emerging technologies, however, will enable full duplex operations in which a base station or mobile device may communicate on downlink and uplink channels simultaneously. Full duplex operations may diminish the efficiency of terrestrial positioning processes.

### SUMMARY

An example method of providing positioning information for a mobile device to a base station according disclosure includes receiving, at the mobile device, a positioning request and an accuracy requirement from the base station, determining one or more positioning reference signal transmissions based on the accuracy requirement, obtaining position measurement information based on the one or more positioning reference signal transmissions, and providing the position measurement information to the base station.

Implementations of such a method may include one or more of the following features. One of the one or more positioning reference signal transmissions may be in a half duplex slot. One of the one or more positioning reference signal transmissions may be in a full duplex slot. The position measurement information may include reference signal time difference measurements. The position measurement information includes RSSI or RTT measurements. A downlink positioning measurement may be obtained by the mobile device concurrently with an uplink transmission from the mobile device. One or more symbols of the downlink positioning measurement may overlap with one or more symbols of the uplink transmission. Slot information may be provided to the base station based on an overlap of the one or more symbols of the downlink positioning measurement and the one or more symbols of the uplink transmission. The slot information may comprise a bit map based on the one or more symbols in the overlap. The slot information may comprise a flag variable or a single bit to indicate a presence of the overlap.

An example of a method of providing position information for a mobile device to a server according to the disclosure includes determining position information for the mobile device, determining a duplex mode configuration associated with the position information, and providing the position information and an indication of the duplex mode configuration to the server.

Implementations of such a method may include one or more of the following features. Determining the position information may include receiving the position information from the mobile device in a wireless signal. Determining the duplex mode configuration may include receiving the indication of the duplex mode configuration from the mobile device in a wireless signal. The indication of the duplex mode configuration may include a beam identification value. The indication of the duplex mode configuration may include slot information indicating that a downlink positioning measurement was obtained by the mobile device concurrently with an uplink transmission from the mobile device. One or more symbols of the downlink positioning measurement may overlap with one or more symbols of the uplink transmission. The slot information may be based on an overlap of the one or more symbols of the downlink positioning measurement and the one or more symbols of the uplink transmission. The slot information may comprise a bit map based on the one or more symbols in the overlap. The slot information may comprise a flag variable or a single bit to indicate a presence of the overlap. Providing the indication of the duplex mode configuration may include indicating the position information was obtained in a full duplex slot. Providing the indication of the duplex mode configuration may include indicating the position information was obtained from a base station operating in a split panel mode.

An example of a method for providing a positioning reference signal muting pattern according to the disclosure includes determining a full duplex scheme including a plurality of full duplex slots, determining the positioning reference signal muting pattern based at least in part on the plurality of full duplex slots, and providing the positioning reference signal muting pattern to a mobile device.

Implementations of such a method may include one or more of the following features. The positioning reference signal muting pattern may be configured to mute positioning reference signals of the plurality of full duplex slots in the full duplex scheme. The positioning reference signal muting pattern may be configured to mute positioning reference signals in one or more in-band full duplex slots in the full duplex scheme, wherein the one or more in-band full duplex slots allow simultaneous uplink and downlink transmission without a guard band. The positioning reference signal muting pattern may be configured to mute positioning reference signals in one or more sub-band full duplex slots in the full duplex scheme, wherein the one or more sub-band full duplex slots allow simultaneous uplink and downlink transmission with a frequency separation that is insufficient to reduce self-interference on the mobile device. The positioning reference signal muting pattern may exclude positioning reference signals in one or more sub-band full duplex slots in the full duplex scheme, wherein the one or more sub-band full duplex slots allow simultaneous uplink and downlink transmission with a frequency separation that is sufficient to reduce self-interference on the mobile device.

An example apparatus according to the disclosure includes a memory, one or more transceivers, a processor communicatively coupled to the memory and the one or more transceivers configured to receive a positioning request and an accuracy requirement from a base station, determine one or more positioning reference signal transmissions based on the accuracy requirement, obtain position measurement information based on the one or more positioning reference signal transmissions; and provide the position measurement information to the base station.

Implementations of such an apparatus may include one or more of the following features. One of the one or more positioning reference signal transmissions may be in a half duplex slot. One of the one or more positioning reference signal transmissions may be in a full duplex slot. The position measurement information may include reference signal time difference measurements. The position measurement information may include RSSI or RTT measurements. A downlink positioning measurement may be obtained with the one or more transceivers concurrently with an uplink transmission with the one or more transceivers. One or more symbols of the downlink positioning measurement may overlap with one or more symbols of the uplink transmission. Slot information may be provided to the base station based on an overlap of the one or more symbols of the downlink positioning measurement and the one or more symbols of the uplink transmission. The slot information may comprise a bit map based on the one or more symbols in the overlap. The slot information may comprise a flag variable or a single bit to indicate a presence of the overlap.

An example apparatus according to the disclosure includes a memory, a processor communicatively coupled to the memory and configured to determine position information for a mobile device, determine a duplex mode configuration associated with the position information, and provide the position information and an indication of the duplex mode configuration to a server.

Implementations of such an apparatus may include one or more of the following features. The indication of the duplex mode configuration may include a beam identification value. The indication of the duplex mode configuration may include slot information indicating that a downlink positioning measurement was obtained by the mobile device concurrently with an uplink transmission from the mobile device. One or more symbols of the downlink positioning measurement may overlap with one or more symbols of the uplink transmission. The slot information may be based on an overlap of the one or more symbols of the downlink positioning measurement and the one or more symbols of the uplink transmission. The slot information may comprise a bit map based on the one or more symbols in the overlap. The slot information may comprise a flag variable or a single bit to indicate a presence of the overlap. The processor may be configured to provide an indication that the position information was obtained in a full duplex slot. The processor may be configured to provide an indication that the position information was obtained from a base station operating in a split panel mode.

An example apparatus according to the disclosure includes a memory, a transceiver, a processor communicatively coupled to the memory and the transceiver and configured to determine a full duplex scheme including a plurality of full duplex slots, determine a positioning reference signal muting pattern based at least in part on the plurality of full duplex slots, and provide the positioning reference signal muting pattern to a mobile device.

Implementations of such an apparatus may include one or more of the following features. The positioning reference signal muting pattern may be configured to mute positioning reference signals of the plurality of full duplex slots in the full duplex scheme. The positioning reference signal muting pattern may be configured to mute positioning reference signals in one or more in-band full duplex slots in the full duplex scheme, wherein the one or more in-band full duplex slots allow simultaneous uplink and downlink transmission without a guard band. The positioning reference signal muting pattern may be configured to mute positioning reference signals in one or more sub-band full duplex slots in the full duplex scheme, wherein the one or more sub-band full duplex slots allow simultaneous uplink and downlink transmission with a frequency separation that is insufficient to reduce self-interference on the mobile device. The positioning reference signal muting pattern may exclude positioning reference signals in one or more sub-band full duplex slots in the full duplex scheme, wherein the one or more sub-band full duplex slots allow simultaneous uplink and downlink transmission with a frequency separation that is sufficient to reduce self-interference on the mobile device.

An example apparatus for providing positioning information for a mobile device to a base station according to the disclosure includes means for receiving a positioning request and an accuracy requirement from the base station, means for determining one or more positioning reference signal transmissions based on the accuracy requirement, means for obtaining position measurement information based on the one or more positioning reference signal transmissions, and means for providing the position measurement information to the base station.

An example non-transitory processor-readable storage medium comprising processor-readable instructions configured to cause one or more processors to provide positioning information for a mobile device to a base station according to the disclosure includes code for receiving a positioning request and an accuracy requirement from the base station, code for determining one or more positioning reference signal transmissions based on the accuracy requirement, code for obtaining position measurement information based on the one or more positioning reference signal transmissions, and code for providing the position measurement information to the base station.

An example apparatus for providing position information for a mobile device to a server according to the disclosure includes means for determining position information for the mobile device, means for determining a duplex mode configuration associated with the position information, and means for providing the position information and an indication of the duplex mode configuration to the server.

An example non-transitory processor-readable storage medium comprising processor-readable instructions configured to cause one or more processors to provide position information for a mobile device to a server according to the disclosure includes code for determining position information for the mobile device, code for determining a duplex mode configuration associated with the position information, and code for providing the position information and an indication of the duplex mode configuration to the server.

An example apparatus for providing a positioning reference signal muting pattern according to the disclosure includes means for determining a full duplex scheme including a plurality of full duplex slots, means for determining a positioning reference signal muting configuration based at least in part on the plurality of full duplex slots, and means for providing the positioning reference signal muting configuration to a mobile device.

An example non-transitory processor-readable storage medium comprising processor-readable instructions configured to cause one or more processors to provide a positioning reference signal muting pattern according to the disclosure includes code for determining a full duplex scheme including a plurality of full duplex slots, code for determining a positioning reference signal muting configuration based at least in part on the plurality of full duplex slots, and code for providing the positioning reference signal muting configuration to a mobile device.

Items and/or techniques described herein may provide one or more of the following capabilities, as well as other capabilities not mentioned. Base stations and user equipment may be configured for full duplex operations. A communication network may be based on full duplex schemes including frames with half duplex and full duplex slots. Base stations may be configured to transmit downlink positioning reference signals (PRS) in half duplex and full duplex slots. The beam widths of downlink PRS transmissions may be increased due to bifurcation of antenna elements between the transmit and receive chains in the base station. The accuracy of position estimates based on PRS transmissions in full duplex slots may be degraded due to the increased PRS beam width and self-interference on the mobile device. Downlink PRS transmissions may be muted in some full duplex slots. Half duplex and full duplex slots may be associated with different accuracy requirements. The use of full duplex slot for positioning may be reported to a location server. The extent of the overlap between a received downlink PRS transmission and an active UL transmission on a mobile device may be captured and reported. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a block diagram conceptually illustrating an example telecommunications system.

FIG. 2 is a block diagram illustrating an example architecture of a distributed radio access network (RAN), in accordance with certain aspects of the present disclosure.

FIGS. 3A-3C illustrate different full duplex communication modes in a telecommunication system.

FIGS. 4A & 4B show examples of different types of full duplex operation.

FIG. 5 illustrates an example spectrum for a full duplex base station and half duplex mobile devices.

FIG. 6 illustrates an example spectrum for a full duplex base station and a full duplex mobile device.

FIGS. 7A and 7B illustrates an example downlink positioning reference signal resource sets.

FIG. 8 illustrates example subframe and slot formats for positioning reference signal (PRS) transmission.

FIG. 9 illustrates an example spectrum for sub-band full duplex positioning reference signal (PRS) transmissions.

FIG. 10 illustrates an example spectrum for full duplex positioning reference signal (PRS) transmissions.

FIG. 11A is a diagram of example beam widths associated with half duplex and full duplex positioning reference signal (PRS) transmissions.

FIG. 11B is an example positioning message flow between a base station and a mobile device.

FIG. 12 is a flow diagram of an example method for providing a positioning reference signal muting pattern.

FIG. 13 is a flow diagram of an example method for muting positioning reference signals based on a full duplex schedule.

FIG. 14 is a flow diagram of an example method for providing position information to a network server.

FIG. 15A is a flow diagram of an example method for receiving position information from a mobile device.

FIG. 15B is a flow diagram of an example method for providing position information to a base station.

FIG. 16 illustrates a block diagram of an example of a computer system.

FIG. 17 is a block diagram of an example mobile device.

FIG. 18 is a block diagram of an example base station.

### DETAILED DESCRIPTION

Techniques are discussed herein for utilizing positioning reference signals (PRS) in full duplex scenarios. A 5G NR deployment may include frames with slots configured for full duplex mode operations. In a full duplex communication mode, antenna systems may have some elements configured to transmit while other elements are configured to receive. The signal to noise ratio of a station or mobile device operating in full duplex mode may be degraded due to self-interference (e.g., transmitter leakage). PRS transmissions may occur during a slot configured for full duplex operations. The beam width of a PRS transmission during full duplex operations may be increased based on a reduced number of antenna elements configured to transmit. The accuracy of a position estimate based on PRS transmissions in full duplex slots may be reduced. The self-interference on the mobile device may further reduce the position estimate. In an example, PRS transmissions in full duplex slots may be explicitly or implicitly muted. In another example, positioning accuracy requirements may be defined for PRS position estimates obtained from PRS transmissions in half duplex and full duplex slots. A full duplex slot may be associated with a reduced or non-existent accuracy requirement (i.e., accuracy requirements may not apply in a full duplex slot). A mobile device may be configured to provide an indication on whether position measurements were obtained in a half duplex or a full duplex slot. For full duplex slots, the mobile device may report whether the PRS signals overlapped with an active uplink (UL) transmission from the mobile device. These techniques are examples only, and not exhaustive.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 3GPP Fifth Generate New Radio (5G NR). 5G NR is an emerging wireless communications technology under development in conjunction with the 5G Technology Forum (5GTF). NR access (e.g., 5G NR) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

The techniques described herein may be used for 5G NR wireless networks and radio technologies, as well as other wireless networks and radio technologies.

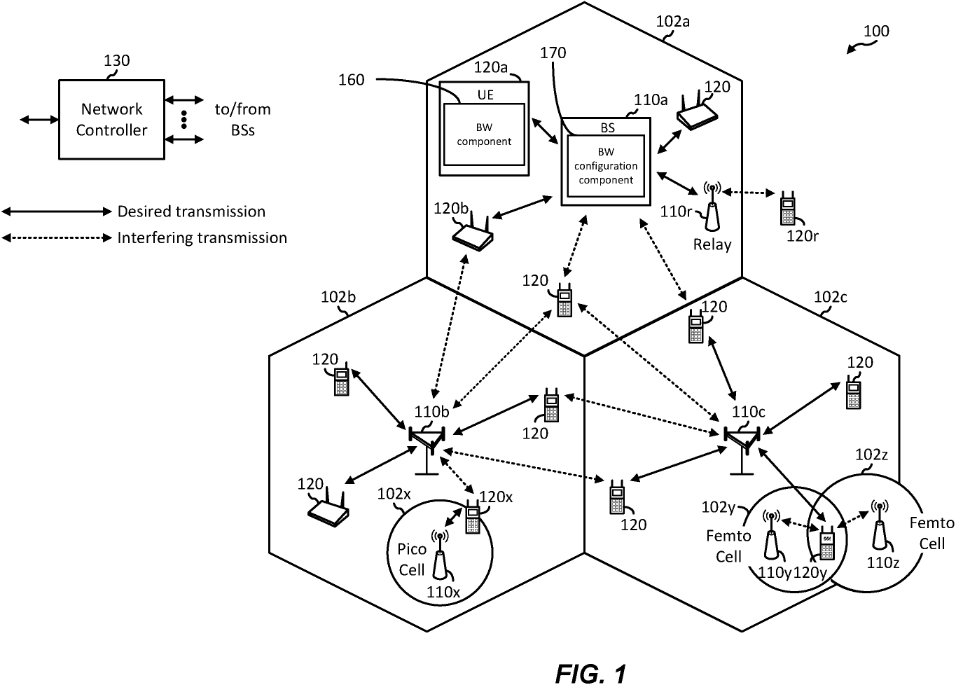

Referring to FIG. 1, an example wireless communication network 100 is shown. The wireless communication network 100 may be a full-duplex NR system (e.g., a full-duplex 5G network). In an example, a mobile device such as a User Equipment (UE) 120a has a bandwidth (BW) component 160 that may be configured for adapting an operating BW of the UE 120a. Similarly, a base station (BS) 110a may include a BW configuration component 170 that may configure a UE, such as UE 120a, to adapt an operating BW.

The wireless communication network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. In some examples, a cell may not necessarily be stationary, and the geographic area of the cell may move according to the location of a mobile BS. In some examples, the BSs may be interconnected to one another and/or to one or more other BSs or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. The BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

The wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. A relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120a, 120b, 120x, 120y, etc.) may be dispersed throughout the wireless communication network 100, and each UE may be stationary or mobile. A UE may also be referred to as a mobile device, a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, ... slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. NR may support transmitting positioning reference signals (PRS) in one or more slots as described herein.

NR may utilize OFDM with a CP on the uplink and downlink and include support for half-duplex operation using TDD. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum). In an example, a the sidelink signals may be configured for full duplex or half duplex operations. A position frequency layer may be used to facilitate full duplex and/or half duplex UE-to-UE transmissions for sidelink positioning applications.

In FIG. 1, a solid line with double arrows indicates desired transmissions between a UE and a serving BS, which is a BS designated to serve the UE on the downlink and/or uplink. A finely dashed line with double arrows indicates potentially interfering transmissions between a UE and a BS.

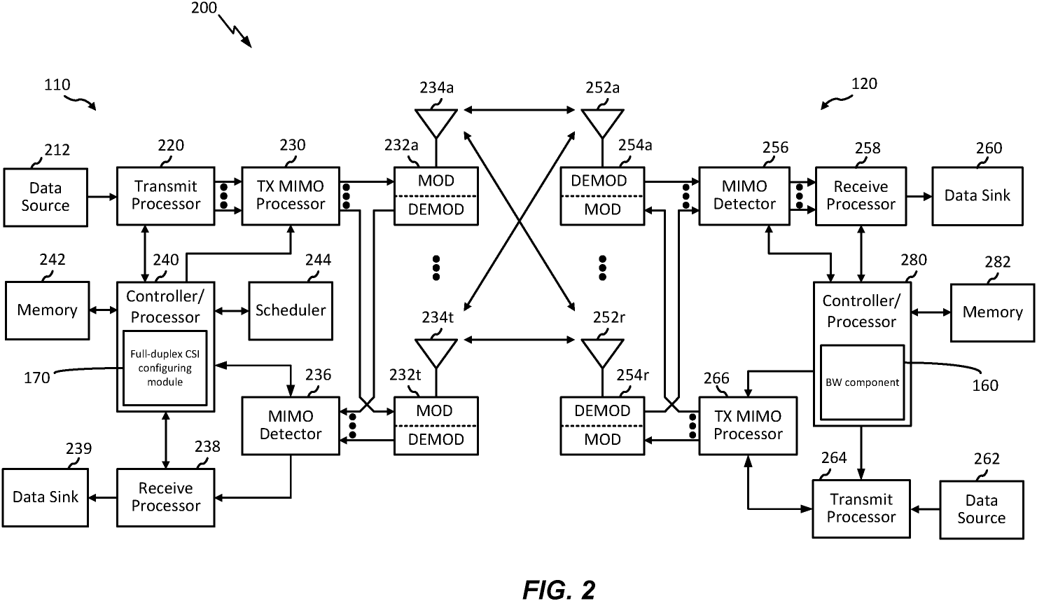

Referring to FIG. 2, example components of BS 110 and UE 120 (e.g., in the wireless communication network 100 of FIG. 1) are shown. The components include antennas 252, processors 266, 258, 264, and/or controller/processor 280 of the UE 120 and/or antennas 234, processors 220, 230, 238, and/or controller/processor 240 of the BS 110 may be used to perform the various techniques and methods described herein.

At the BS 110, a transmit processor 220 may receive data from a data source 212 and control information from a controller/processor 240. For LTE systems, the control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), cell-specific reference signal (CRS), and positioning reference signal (PRS). For NR systems, the control information may include logical and transport channels including a broadcast control channel (BCCH), a paging control channel (PCCH), a common control channel (CCCH), a dedicated control channel (DCCH), a dedicated traffic channel (DTCH), a broadcast channel (BCH), a paging channel (PCH) and a downlink shared channel (DL-SCH). The physical channels in a 5G NR system may include a PBCH, PDCCH, and a PDSCH. The physical signals may include demodulate reference signals (DM-RS), phase tracking reference signal (PT-RS), a channel state information reference signal (CSI-RS), primary and secondary synchronization signals (PSS/SSS) and downlink PRS (DL PRS).

A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the base station 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The controller/processor 240 and/or other processors and modules at the BS 110 may perform or direct the execution of processes for the techniques described herein. The memories 242 and 282 may store data and program codes for BS 110 and UE 120, respectively. A scheduler 244 may schedule UEs for data transmission on the downlink and/or uplink.

5G NR wireless networks are expected to provide ultra-high data rates and support a wide scope of application scenarios. Wireless full duplex (FD) communications is an emerging technique and is theoretically capable of doubling the link capacity when compared with half duplex (HD) communications. The main idea of wireless full duplex communications is to enable radio network nodes to transmit and receive simultaneously on the same frequency band in the same time slot. This contrasts with conventional half duplex operation, where transmission and reception either differ in time or in frequency. The wireless communication network 100 may support various FD communication modes.

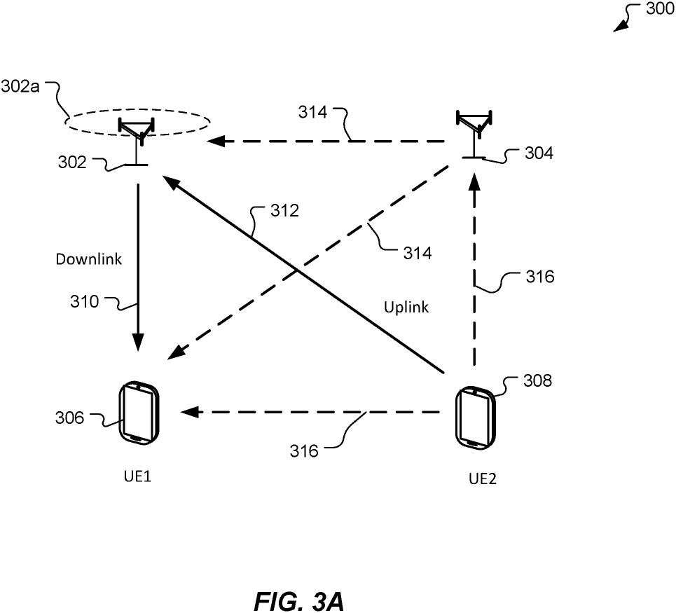

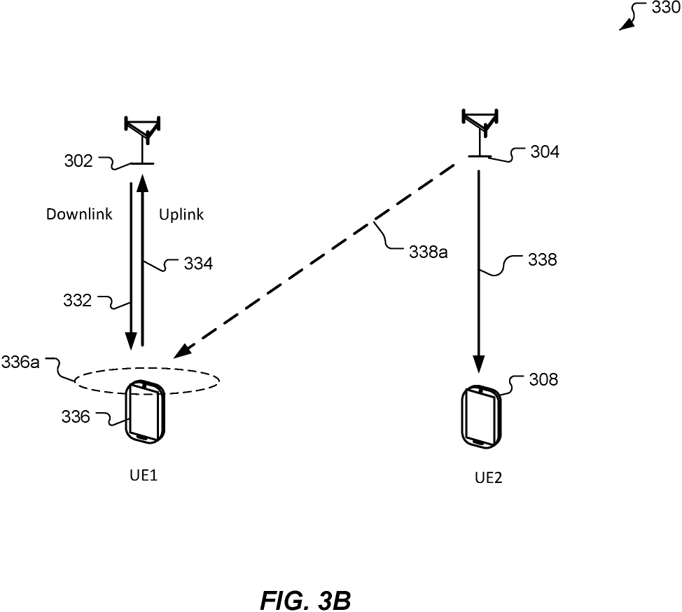

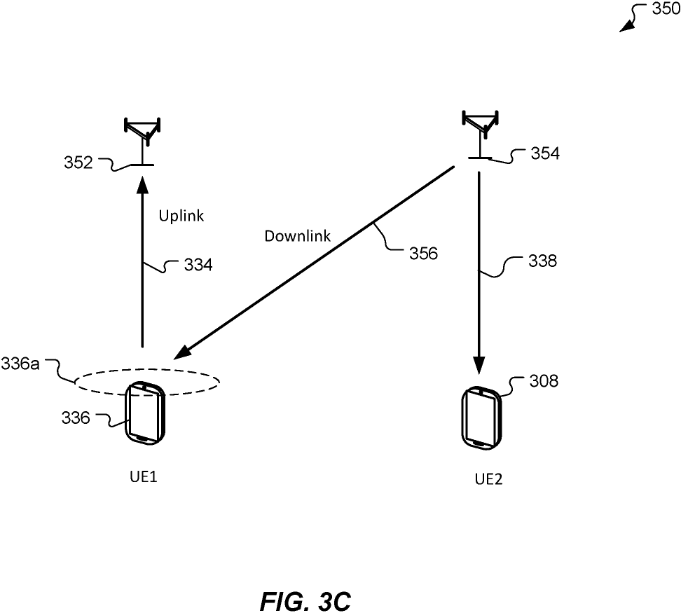

Referring to FIG. 3A, with further reference to FIGS. 1 and 2, an illustration 300 of full duplex communication mode with a full duplex base station and a half duplex UE is shown. The illustration includes the FD BS 302, a HD BS 304, a first HD UE 306, and a second HD UE 308. The FD BS 302 can communicate simultaneously in UL and DL with the two HD UEs 306, 308 using the same radio resources. For example, the FD BS 302 may communicate with the first HD UE 306 via the downlink 310 and with the second HD UE 308 with the uplink 312. The FD BS 302 may be susceptible to self-interference 302a from its downlink to uplink operation, as well as interference 312 from other gNBs such as the HD BS 304. The first HD UE 306 may be susceptible to interference 314 from the HD BS 304 and interference 316 from the second HD UE 308. In general, the self-interference 302a (or transmitter leakage) refers to the signal that leaks from the device transmitter to its own receiver.

Referring to FIG. 3B, an illustration 330 of another full duplex communication mode with a full duplex base station and a full duplex UE is shown. The illustration 330 includes the FD BS 302, the HD BS 304, a FD UE 336, and the HD UE 308. The FD BS 302 and the FD UE 336 are configured to communicate simultaneously via an UL 334 and a DL 332 using the same radio resources. The HD BS 304 is communicating with the HD UE 308 via a DL 338. While communicating, the FD UE 336 may be susceptible to self-interference 336a, and interference 338a from other gNB(s) such as the HD BS 304. The FD UE 336 may also be susceptible to interference transmitting from the HD UE 308.

Referring to FIG. 3C, an illustration 350 of another full duplex communication mode with full duplex UE. The illustration 350 includes a first HD BS 352, a second HD BS 354, the FD UE 336 and the HD UE 308. The FD UE 336 is configured to communicate simultaneously in UL and DL with multiple transmission-reception points (e.g., multiple BSs) using the same radio resources. For example, the FD UE 336 may simultaneously communicate with the first HD BS 352 via the UL 334, and with the second HD BS 354 via the DL 356. The FD UE 336 may be susceptible to self-interference 336a from UL to DL operation. In an example, both UE1 336 and UE2 308 may be configured as FD UEs and capable of full duplex communications via device-to-device (D2D) sidelinks (e.g., PC5).

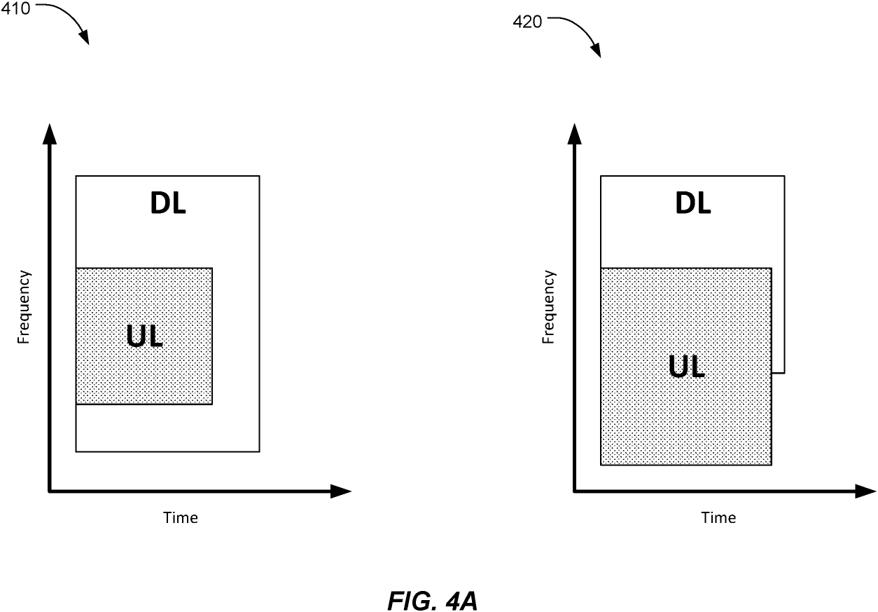

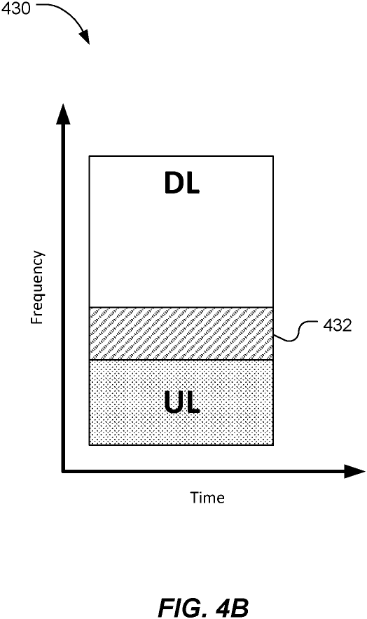

In addition to supporting various FD communication modes (also referred to herein as deployments), the wireless communication system may support various types of FD operation. In-band full duplex (IBFD), for example, is one type of FD operation in which devices can transmit and receive at the same time and on the same frequency resources. As shown in 410 of FIG. 4A, in one aspect, the DL and UL may fully share the same IBFD time/frequency resource (e.g., there may be a full overlap of the DL and UL allocations within the IBFD time/frequency resource). As shown in 420 of FIG. 4A, in one aspect, the DL and UL may partially share the same IBFD time/frequency resource (e.g., there may be a partial overlap of the DL and UL allocations within the IBFD time/frequency resource).

Sub-band FDD (also referred to as flexible duplex) is another type of FD operation in which devices can transmit and receive at the same time but on different frequency resources. Referring to the diagram 430 in FIG. 4B, the DL resource may be separated from the UL resource in the frequency domain by a guard band 432. This mode of operations reduces the self-interference cancellation requirements on the FD device since the leakage is lower.

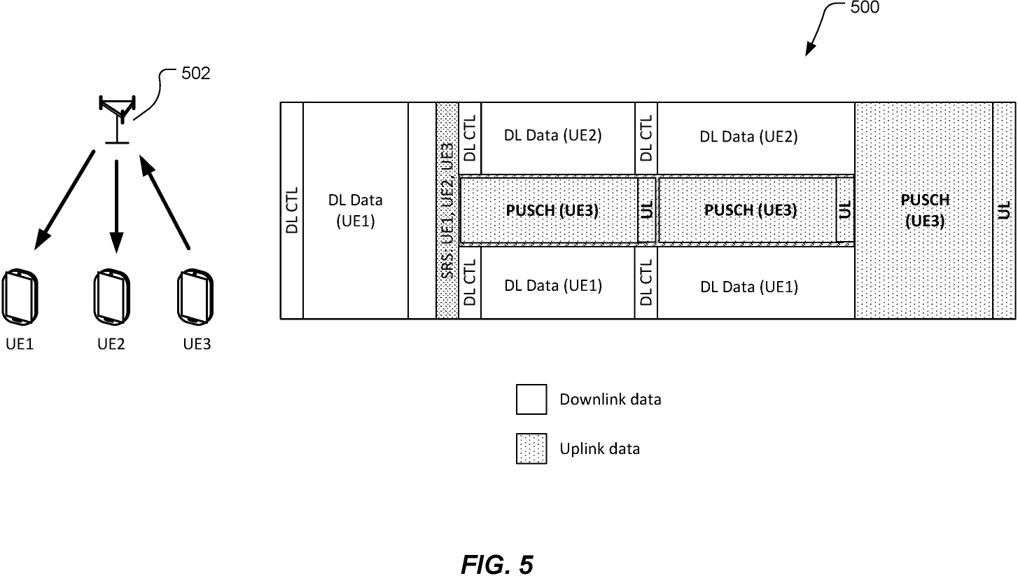

Referring to FIG. 5, with further reference to FIG. 1-4B, an example spectrum 500 for a full duplex base station and half duplex mobile devices is shown. In some aspects, there may be flexible DL/UL operation in time (across and within slots) and across multiple UEs. FIG. 5 illustrates an example use of time/frequency resources for a FD BS 502 (e.g., a gNB) and a plurality of HD UEs (e.g., UE1, UE2, and UE3). As shown in the spectrum 500, there may be simultaneous PDSCH and PUSCH grants for the same subframe/slot (for different UEs).

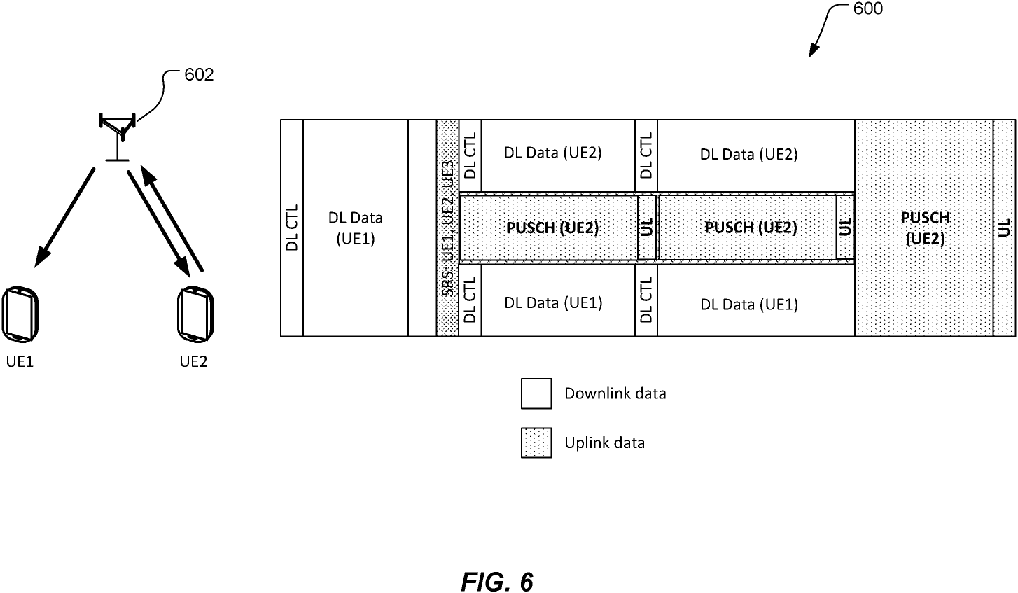

Referring to FIG. 6, with further reference to FIGS. 1-5, an example spectrum 600 for full duplex base station and a full duplex mobile device is shown. FIG. 6 illustrates another example use of time/frequency resources for a FD BS 602 and FD UEs. As shown in the spectrum 600, compared to spectrum 500 in FIG. 5, there may be simultaneous PDSCH and PUSCH grants for the same subframe/slots for the same UE (e.g., UE2) and/or different UEs. For example, for a FD UE (e.g., UE2) there may be a simultaneous UL and DL grant.

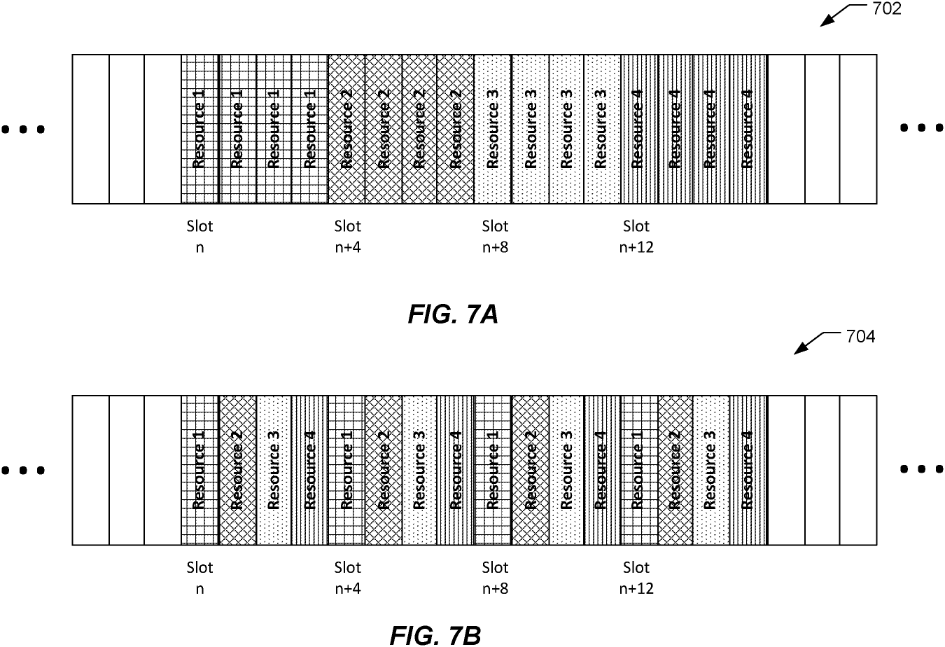

Referring to FIGS. 7A and 7B, an exemplary DL-PRS resource sets are shown. In general, a DL-PRS resource set is a collection of PRS resources across one base station (e.g., TRP) which have the same periodicity, a common muting pattern configuration and the same repetition factor across slots. A first DL-PRS resource set 702 includes 4 resources and a repetition factor of 4, with a time-gap equal to 1 slot. A second DL-PRS resource set 704 includes 4 resources and a repetition factor of 4 with a time-gap equal to 4 slots. The repetition factor indicates the number of times each PRS resource is repeated in each single instance of the PRS resource set (e.g., values of 1, 2, 4, 6, 8, 16, 32). The time-gap represents the offset in units of slots between two repeated instances of a DL PRS resource corresponding to the same PRS resource ID within a single instance of the DL PRS resource set (e.g., values of 1, 2, 4, 8, 16, 32). The time duration spanned by one DL PRS Resource set containing repeated DL PRS resources does not exceed PRS-periodicity. The repetition of a DL PRS resource enables receiver beam sweeping across repetitions and combining RF gains to increase coverage. The repetition may also enable intra-instance muting.

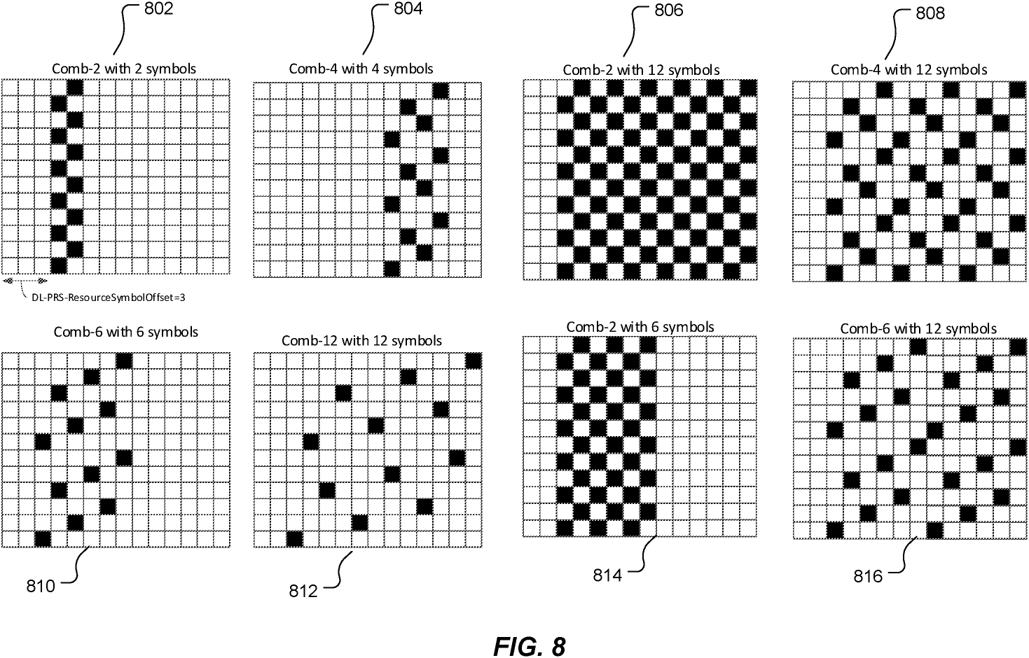

Referring to FIG. 8, example subframe and slot formats for positioning reference signal transmission are shown. The example subframe and slot formats are included in the DL-PRS resource sets depicted in FIGS. 7A and 7B. The subframes and slot formats in FIG. 8 are examples and not limitations and include a comb-2 with 2 symbols format 802, a comb-4 with 4 symbols format 804, a comb-2 with 12 symbols format 806, a comb-4 with 12 symbols format 808, a comb-6 with 6 symbols format 810, a comb-12 with 12 symbols format 812, a comb-2 with 6 symbols format 814, and a comb-6 with 12 symbols format 816. In general, a subframe may include 14 symbol periods with indices 0 to 13. The subframe and slot formats may be used for a Physical Broadcast Channel (PBCH). Typically, a base station may transmit the PRS from antenna port 6 on one or more slots in each subframe configured for PRS transmission. The base station may avoid transmitting the PRS on resource elements allocated to the PBCH, a primary synchronization signal (PSS), or a secondary synchronization signal (SSS) regardless of their antenna ports. The cell may generate reference symbols for the PRS based on a cell ID, a symbol period index, and a slot index. Generally, a UE may be able to distinguish the PRS from different cells.

A base station may transmit the DL PRS over a particular PRS bandwidth, which may be configured by higher layers. The base station may transmit the PRS on subcarriers spaced apart across the PRS bandwidth. The base station may also transmit the PRS based on the parameters such as PRS periodicity T_{PRS}, subframe offset Δ_{PRS}, and PRS duration N_{PRS}. PRS periodicity is the periodicity at which the PRS is transmitted. The PRS periodicity may be, for example, 160, 320, 640 or 1280 ms. Subframe offset indicates specific subframes in which the PRS is transmitted. And PRS duration indicates the number of consecutive subframes in which the PRS is transmitted in each period of PRS transmission (PRS occasion). The PRS duration may be, for example, 1, 2, 4 or 6 ms.

The PRS periodicity T_{PRS} and the subframe offset Δ_{PRS} may be conveyed via a PRS configuration index I_{PRS}. The PRS configuration index and the PRS duration may be configured independently by higher layers. A set of N_{PRS} consecutive subframes in which the PRS is transmitted may be referred to as a PRS occasion. Each PRS occasion may be enabled or muted, for example, the UE may apply a muting bit to each cell. As will be discussed, a muting pattern may apply to PRS transmissions in full duplex slots. A PRS resource set is a collection of PRS resources across a base station which have the same periodicity, a common muting pattern configuration, and the same repetition factor across slots (e.g., 1, 2, 4, 6, 8, 16, 32 slots).

In an example, a positioning frequency layer may be a collection of PRS Resource Sets across one or more base stations. The positioning frequency layer may have the same subcarrier spacing (SCS) and cyclic prefix (CP) type, the same point-A, the same value of DL PRS Bandwidth, the same start PRB, and the same value of comb-size. The numerologies supported for PDSCH are supported for PRS.

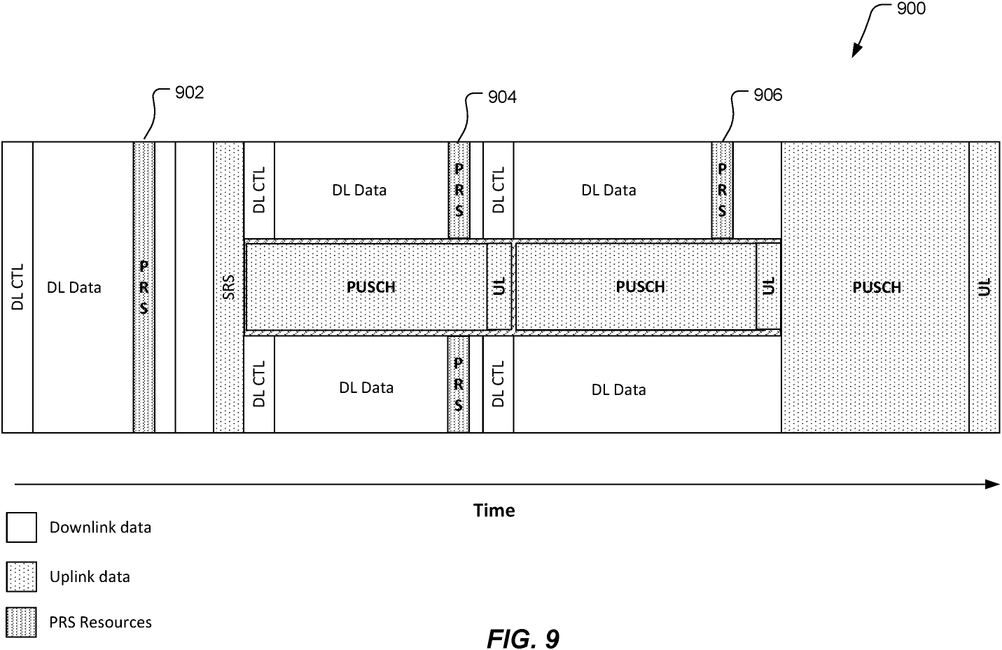

Referring to FIG. 9, an example spectrum 900 for sub-band full duplex positioning reference signals (PRS) is shown. The spectrum 900 is an example use of time/frequency resources of a FD UE, such as the full duplex spectrums 500, 600, with PRS resources added. For example, the spectrum 900 includes a first DL PRS transmission 902, a second DL PRS transmission 904 and a third DL PRS transmission 906. The first DL PRS transmission 902 occurs during a downlink region and is not overlapped with the uplink regions (e.g., the PUSCH). The second DL PRS transmission 904 is overlapped with the uplink regions. The third DL PRS transmission 906 occurs in a full duplex slot but is not considered overlapped with the uplink region because it only occupies a portion of the DL bandwidth.

In an example, a BS 110 or other resource in the wireless communications network 100 may configure the PRS resources based on whether a slot is in a half duplex (HD) region or a full duplex (FD) region. The positioning frequency layer may be expanded by including a field or other information element (IE) to indicate information of slot class (either HD or FD) in the definition of the positioning frequency layer. The positioning frequency layer may include a collection of PRS resource sets across one or more base stations (e.g., TRPs) with the same kind of HD or FD slots. The network may configure the PRS separately for FD operation and HD operation. For example, one positioning frequency layer may be configured for FD slots, and another positioning frequency layer may be provided for HD slots.

A PRS resource may be configured across a wide bandwidth and may span across HD and FD regions. For example, the second DL PRS transmission 904 spans across the DL and UL portions of the slot. In another example, a PRS resource may be configured in a smaller bandwidth such as the third DL PRS transmission 906, which is separated from the UL portion by a guard band. In an example, a FD UE may be configured to process the DL PRS transmissions, or portions of the DL PRS transmissions, which do not collide with the UL sub-bands. For example, the FD UE may process the first, second and third DL PRS transmissions 902, 904, 906, excluding any colliding sub-band portions (e.g., in the second DL PRS transmission 904). Processing of the second DL PRS transmission 904 while excluding the colliding sub-band portion will produce a reasonable correlation peak and enable a position estimate. In an example, the processed portion of the second DL PRS transmissions 904 may be correlated with the first DL PRS transmissions 902 to generate a correlation peak.

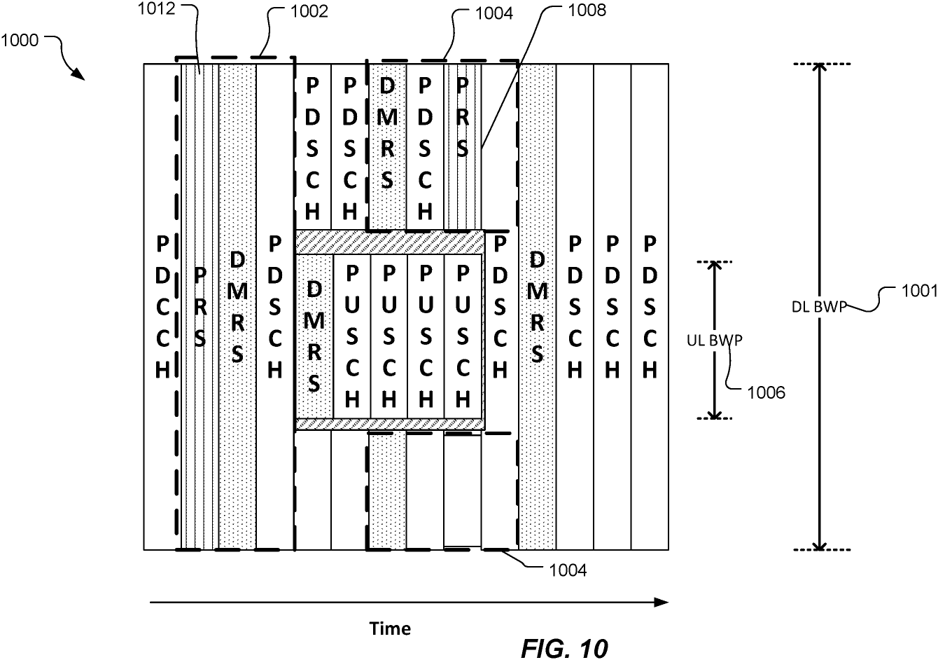

Referring to FIG. 10, an example spectrum 1000 for full duplex positioning reference signals (PRS) transmissions is shown. In an example, to avoid bandwidth part (BWP) switching delays, the DL PRS transmissions may be configured and processed within indicated resource bandwidths (BWs) within an active BWP. The active DL BWP 1001 may span across an active UL BWP 1006. A first resource BW 1002 and a second resource BW 1004 may be defined within the active DL BWP 1001. The second resource BW 1004 comprises a disjoint set of frequency resources across the DL BWP 1001 (i.e., it is not continuous throughout the DL BWP 1001). The second resource BW 1004 includes frequencies that are outside of the active UL BWP 1006. The resource BWs 1002, 1004 may be configured via radio resource control (RRC) signaling and the indication of the resource BWs may be dynamic (e.g., downlink control information (DCI) based). The first resource BW 1002 includes a first DL PRS transmission 1012, and a portion of the second resource BW 1004 includes a second DL PRS transmission 1008.

In an example, the UEs may be configured based on their capabilities as an HD UE or a FD UE. A HD UE may be configured to process the first DL PRS transmission 1012 and to skip the second DL PRS reception/processing (i.e., the PRS in the full duplex region). The performance of a FD UE may vary based on the type of full duplex operation. In an example, FIG. 10 illustrates an example of duplex operation wherein the active UL BWP 1006 may create a partial overlap between the UL and DL resource BWs. In an example, a DL PRS transmission may be configured across the entirety of the DL BWP 1001 and thus overlap with the UL BWP 1006. In another example, as depicted in FIG. 10, the second DL PRS transmission 1008 is configured in only a portion of the DL BWP 1001 and thus does not overlap with the UL BWP 1006. The remainder of the slot occupied by the second DL PRS transmission 1008 may be utilized for the PDSCH or other DL resources.

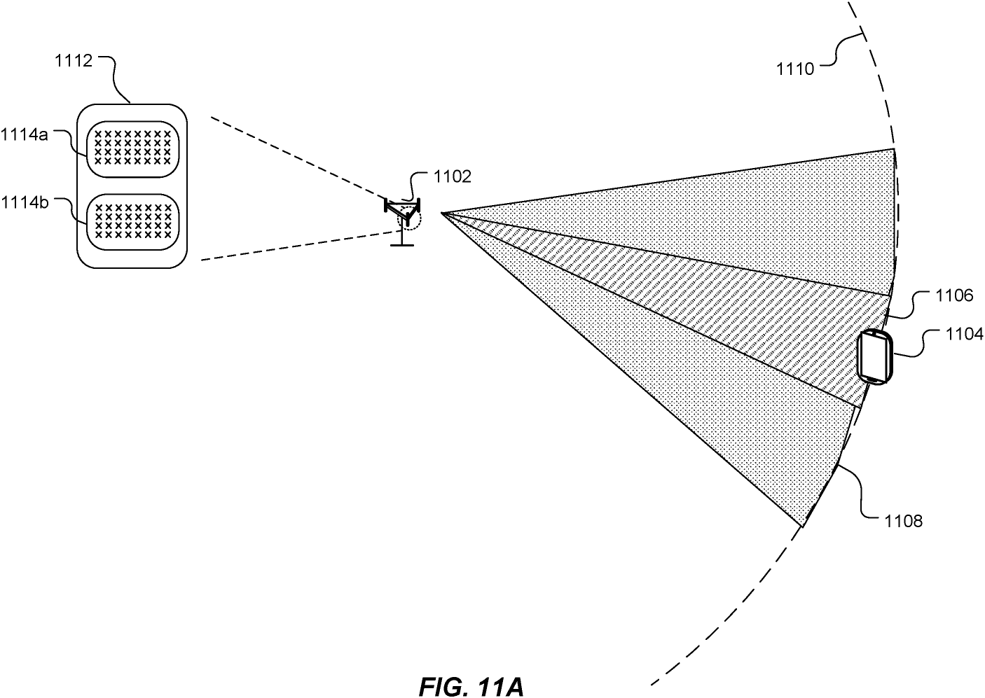

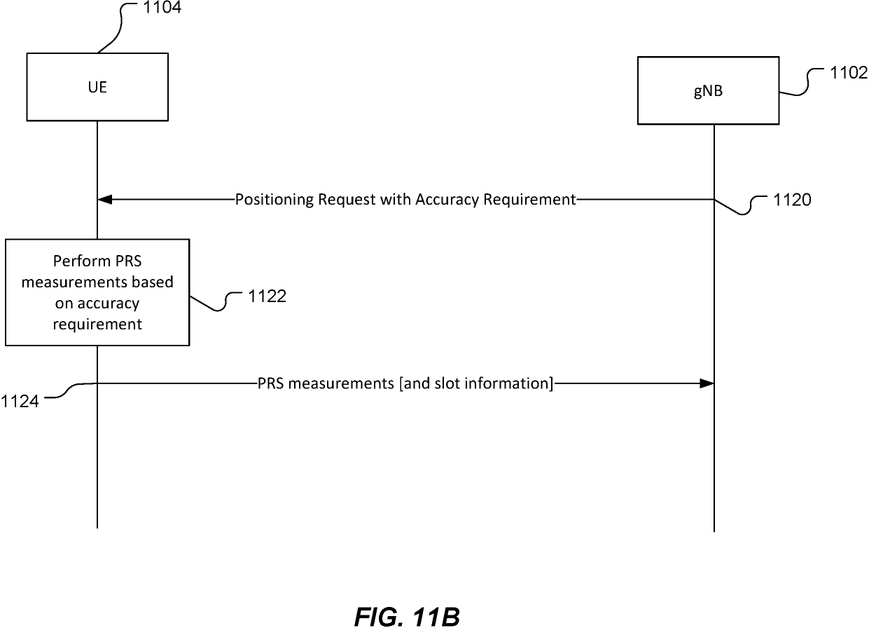

Referring to FIG. 11A, with further reference to FIGS. 1-10, example beam widths associated with HD and FD PRS transmissions are shown. A base station (BS) 1002, such as a BS 110a, includes a plurality of antenna structures 1112 comprising one or more antenna panels 1114a-b, each containing a plurality of antenna elements. In HD operation, the BS 1002 may utilize the antenna panels 1114a-b exclusively for transmission or reception. The increased number of antenna elements used for PRS transmission allows for increased beam forming and narrow beam widths. In contrast, in FD operation, only a portion of the antenna elements in one or more of the panels 1114a-b are used for transmitting while the remaining portion of the antenna elements are used for receiving. This is also generally referred to as a split panel operation. As a result, the BS 1102 will have constraints on the degrees of freedom and reduced beam forming capabilities. The bifurcation of the antenna elements for the transmit and receive chains during full duplex operation also impacts the beam forming capabilities of a mobile device.

In operation, when the BS 1102 and a UE 1104 are operating in HD mode, the BS 1102 may generate a DL PRS transmission having a first beam width 1106. The UE 1104 is an example of a UE 120 in FIG. 1. PRS measurement information (e.g., timing information) may be used to estimate a range 1110 between the BS 1102 and the UE 1104. The location the UE 1104 may be estimated within the intersection of the first beam width 1106 and the estimated rage 1110. The corresponding Angle of Departure (AoD) and Angle of Arrival (AoA) measurements may also be based on the first beam width 1106. When the BS 1102 is in FD mode, the DL PRS transmissions may have a second beam width 1108 due to the reduction in transmitting antenna elements in the antenna panels 1114a-b. As depicted, the second beam width 1108 is wider than the first beam width 1106 and the corresponding position estimate for the UE 1104 is less accurate. The wider beam width also impacts the corresponding AoD and AoA measurements. Additionally, the self-interference on the UE 1104 caused by the simultaneous reception of the DL PRS transmission from a base station (e.g., BS 1102) and UL transmissions may further reduce the accuracy of the resulting position estimate. The DL PRS transmissions in FD mode may negatively impact the accuracy of a position estimate for the UE 1104 and thus may be insufficient for some positioning applications.

The inaccuracies associated with position estimates in a FD slot may be based on combinations of reduced numbers of transmit antennas (e.g., wider beam widths) and SNR issues associated with self-interference on the receiving UE which is actively communicating via an UL BWP. The self-interference may be mitigated with a sufficient guard band between the DL BWP and the UL BWP. Thus, an estimated position based on transmissions in a FD slot with a large guard band may be more accurate than one generated in a FD slot with a smaller guard band.

In an embodiment, the inaccuracies associated with FD PRS measurements may be mitigated by eliminating support for DL PRS transmissions in FD slots. In an example, a PRS muting pattern may be configured to mute DL PRS transmissions in FD slots. That is, referring to FIG. 9, a PRS resource set may include a muting pattern to mute the second DL PRS transmission 904 and the third DL PRS transmission 906 since they are in FD slots. In another example, only the DL PRS transmissions which overlap with an UL region in a FD slot may be muted (e.g., only the second DL PRS transmission 904 is muted). The muting pattern may also be configured to minimize the impact of self-interference on the BS 1102 and the UE 1104 caused by the DL PRS transmissions.

In an embodiment, the reduced accuracy associated with position estimates obtained during a FD slot may be considered and reported. For example, a position accuracy requirement may be defined for each antenna configuration at the BS 1102 and the UE 1104 where the AoA/AoD accuracy requirements will not apply in a FD slot. In an example, the AoA/AoD accuracy requirements may be different (e.g., have separate tables or accuracy parameters) for measurements obtained in FD and HD slots. The UE 1104, and/or the BS 1102 may report whether a measurement was obtained using a FD slot (or during other split antenna panel operations which may impact the beam forming and the corresponding position accuracy). A network server (not shown in FIG. 11A) may utilize the reported information to determine if the corresponding position estimate meets a required accuracy. For example, an E911 procedure may exclude position estimates based on such FD measurements.

In an embodiment, if a position estimate is based on measurements made during a FD slot, the UE 1104 or the BS 1102 may be configured to report whether the DL PRS transmission overlapped with an active UL transmission from the UE 1104. For example, referring to FIG. 10, if a DL PRS transmission occupied the entire DL BWP 1001 and the same time the UE was transmitting in the UL BWP 1006, a power of the DL PRS transmission would overlap with UL transmission. In this case, the UE 1104 may be configured to generate a bitmap with the same length of the DL PRS transmission in the time domain, where each bit indicates whether there was an overlap with an UL symbol or not. The bitmap may be included in a message reporting the PRS measurements. In an example, the UE 1104 may report that an overlap existed at some point during the DL PRS transmission with a flag (e.g., one bit) in a PRS measurement message. In an example, a DL PRS transmission may be included in a DL BWP that is separated from an UL BWP by a sufficient frequency gap (i.e., guard band). The frequency gap may be sufficient to reduce the impact of self-interference on the UE 1104 caused when it is transmitting during the reception of the DL PRS transmission.

Referring to FIG. 11B, with further reference to FIG. 11A, an example positioning message flow between a base station 1102 and a mobile device (i.e., UE 1104) is shown. The base station 1102 may be a gNB configured to communicate with a communication network, such as a 5G NR network (not shown in FIG. 11B). The communication network may include one or more servers such as a Location Management Function (LMF) configured to communicate with the BS 1102 and the UE 1104. In an example, the LMF may communicate with the BS 1102 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the BS 1102 and the LMF. In an example, the LMF and the UE 1104 may communicate using an LTE Positioning Protocol (LPP), which may be defined in 3GPP TS 36.355. The LMF and the UE 1104 may also or instead communicate using a New Radio Positioning Protocol (which may be referred to as NPP or NRPP), which may be the same as, similar to, or an extension of LPP. LPP and/or NPP messages may be transferred between the UE 1104 and the LMF via the serving BS 1102. For example, LPP and/or NPP messages may be transferred between the LMF and other network servers such as an Access and Mobility Management Function (AMF) using a 5G Location Services Application Protocol (LCS AP) and may be transferred between the AMF and the UE 1104 using a 5G Non-Access Stratum (NAS) protocol. Other messages and protocols may also be used for communications between the UE 1104, the BS 1102 and/or a communication network.

An LPP or NPP message sent from a communication network to the UE 1104, via the BS 1102 may instruct the UE 1104 to do a variety of things depending on the desired functionality. For example, a positioning request with accuracy requirement message 1120 may instruct the UE 1104 to obtain one or more measurement quantities (e.g., beam ID, beam width, mean angle, RSTD, RSRP, RSRQ measurements, slot duplex configuration) of DL PRS transmitted within particular cells supported by one or more base stations (e.g., BS 1102, BSs 110a-c, etc). The positioning request with accuracy requirement message 1120 may or may not include an indication of an accuracy requirement. In an example, the accuracy requirement may preclude the use of DL PRS in FD slots due to the associated beam width and self-interference issues previously described. In another example, the accuracy requirement may allow the use of DL PRS in FD slots provided there is a sufficient guard band to reduce the inaccuracies due to self-interference. In an example, the positioning request message 1120 may not include an accuracy requirement (or indicate a minimal requirement) which will allow for position estimates based on DL PRS measurements in FD slots.

At stage 1122, the UE 1104 is configured to perform PRS measurements based on the accuracy requirement (or non-requirement). For example, a weather application may only require a general location of the mobile device (e.g., a low level of accuracy) and thus a position estimate based on DL PRS measurements in a FD slot will be sufficient. In another example, a location based service search (i.e., find a nearby restaurant) may require a medium level of accuracy which may be satisfied by a position estimate based on DL PRS measurements in a FD slot with a sufficiently large guard band (i.e., to reduce the impact of the self-interference). A location sensitive application, such as emergency location, may require a high degree of accuracy and thus preclude the use of DL PRS measurements in a FD slot. In such an example, the UE 1104 may utilize DL PRS measurements in HD slots (e.g., the first DL PRS transmissions 902, 1012), or obtain an estimated position via other terrestrial or satellite based techniques. Other accuracy requirements may be defined. For example, FD and HD operations may have separate tables to define the require accuracy requirements for RSTD, OTDOA, AoA, and AoD.

The UE 1104 may be configured to provide the PRS measurements obtained at stage 1122 back to the communications network via the BS 1102 in a PRS measurements message 1124. For example, the UE 1104 may send the measurement quantities back to the BS 1102 via wireless and/or wired communications (e.g. an LPP or NPP message (e.g., inside a 5G NAS message)). In an example, the BS 1102 may be configured to report to the LMF that the measurements were performed using FD or other split panel operation. In an example, the UE 1104 may be configured to compute a position estimate based on PRS measurements and provide the estimated position in the PRS measurement message 1124.

In an example, the UE 1104 may be configured to provide optional slot information to inform the LMF that the PRS measurements were obtained from DL PRS transmissions that were overlapped with an active UL transmission from the UE 1104. In one example, the slot information may be a bit map with the same length of the PRS in the time domain. Each bit may show whether there was an overlap with an UL symbol or not. In another example, the slot information may be a single bit (or other flag variable) which indicates in general that there was an overlap or not. The single bit may be used to reduce the signaling overhead. In another example, the slot information may be excluded from the PRS measurement message 1124 if the active UL transmission had a sufficient frequency gap (e.g., guard band) with the DL PRS transmission. The slot information may be useful in scenarios where the BS 1102 does not know whether the UE 1104 is actually performing an active UL transmission or not (such as RACH or a configured grant).

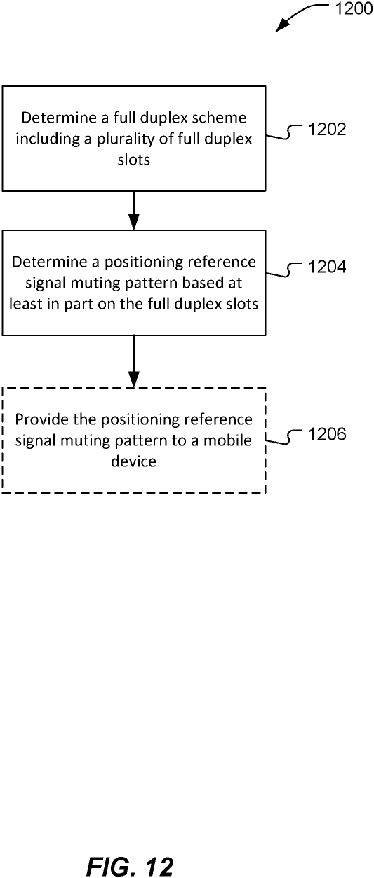

Referring to FIG. 12, with further reference to FIG. 1-11B, a method 1200 for providing a positioning reference signal muting pattern includes the stages shown. The method 1200 is, however, an example only and not limiting. The method 1200 may be altered, e.g., by having stages added, removed, rearranged, combined, performed concurrently, and/or having single stages split into multiple stages. For example, stage 1206 is optional as a muting configuration may not be provided to a mobile device.

At stage 1202, the method includes determining a full duplex scheme including a plurality of full duplex slots. The BS 1102 is a means for determining the full duplex scheme. A communication network may be configured for full duplex schemes including frames with slots configured for simultaneous DL and UL operations. The BS 1102 may be configured based on a full duplex scheme to align transmit and receive chains based on a full duplex slot plan. A full duplex slot, such as depicted in FIGS. 9 and 10, includes periods where the BS 1102 may simultaneously transmit on DL resources and receive on UL resources.

At stage 1204, the method includes determining a positioning reference signal muting pattern based at least in part on the full duplex slots. The BS 1102 is a means for determining a positioning reference signal muting pattern. A position frequency layer may include a collection of PRS resource sets. In general, a DL-PRS resource set is a collection of PRS resources across one base station (e.g., TRP) which have the same periodicity, a common muting pattern configuration and the same repetition factor across slots. The BS 1102, or other network server, may be configured to align the muting pattern with the full duplex slots such that DL PRS transmissions are not transmitted during the scheduled full duplex slots. For example, the output power of the DL PRS transmissions during the full duplex slots are significantly reduced. In general, muting the DL PRS transmission provides an advantage of reducing self-interference on the BS 1102 and thus may help the SNR for received UL signals. In an example, a full duplex slot which include a sufficient guard band (e.g., sufficient to reduce self-interference) may not be muted.

At stage 1206, the method optionally includes providing the positioning reference signal muting pattern to the mobile device. The BS 1102 is a means for providing the muting pattern. In an example, the parameters in the PRS resource sets, including the muting pattern, may be provided to the UE 1104 via RRC signaling or other messaging protocols. The UE 1104 may also receive the slot plan associated with the full duplex schema. In an example, the UE 1104 may be explicitly aware of the muting pattern based on the PRS resource information. In another example, the UE 1104 may implicitly infer the DL PRS is muted in a full duplex slot and any UL PRS should not be transmitted in a full duplex slot.

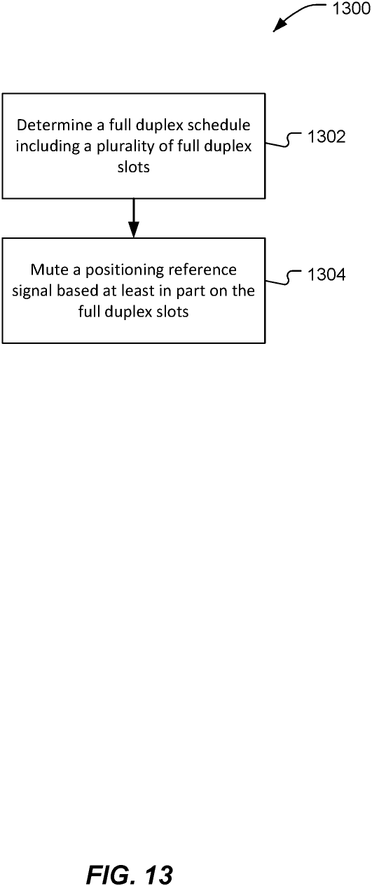

Referring to FIG. 13, with further reference to FIG. 10, a method 1300 for muting positioning reference signals based on a full duplex schedule includes the stages shown. The method 1300 is, however, an example only and not limiting. The method 1300 may be altered, e.g., by having stages added, removed, rearranged, combined, performed concurrently, and/or having single stages split into multiple stages.

At stage 1302, the method includes determining a full duplex schedule including a plurality of full duplex slots. The UE 1104 is a means for determining a full duplex schedule. The UE 1104 may receive slot information associated with a full duplex scheme from a base station (e.g., BS 1102) via RRC signaling or other messaging protocols. The slot information may include indications of which slots are configured for full duplex operations.

At stage 1304, the method includes muting a position reference signal based at least in part on the full duplex slots. The UE 1104 is a means for muting reception of PRS transmission. The BS 1102 may be configured to provide DL PRS transmissions for half duplex slots (e.g., the first DL PRS transmission 902) and full duplex slots (e.g., the second and third DL PRS transmissions 904, 906). In an example, the UE 1104 may mute (i.e., not attempt to receive) the DL PRS transmissions in the full duplex slots (e.g., the UE 1104 will not process the second and third DL PRS transmissions 904, 906). In an example, the UE 1104 may be configured to mute only the DL PRS transmissions which occur when the UE 1104 is itself transmitting in a full duplex slot. That is, the UE 1104 may be configured receive a DL PRS transmission in a full duplex slot if the UE 1104 is not transmitting during that slot.

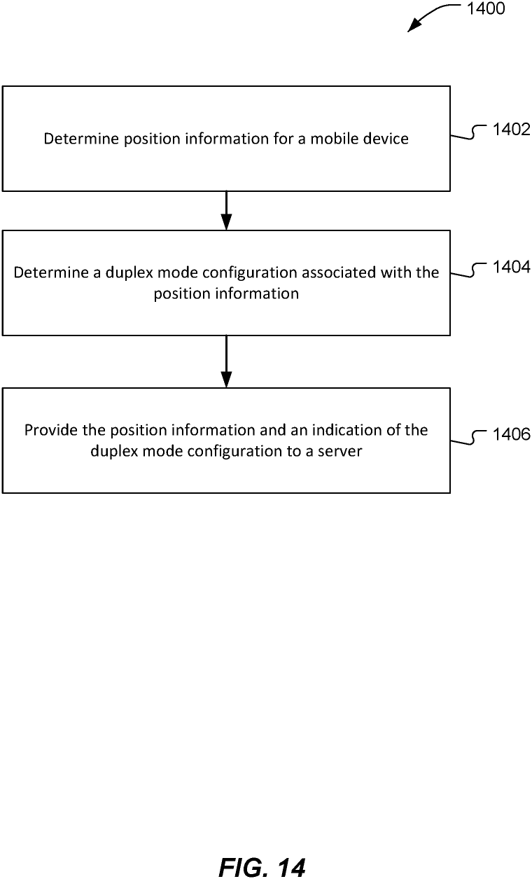

Referring to FIG. 14, with further reference to FIG. 11B, a method 1400 for providing position information to a network server includes the stages shown. The method 1400 is, however, an example only and not limiting. The method 1400 may be altered, e.g., by having stages added, removed, rearranged, combined, performed concurrently, and/or having single stages split into multiple stages.

At stage 1402, the method includes determining position information for a mobile device. The BS 1102 is a means for determining position information. The BS 1102 may be configured to receive PRS measurement information via a PRS measurement message 1124. The PRS measurement message 1124 may include an indication that the PRS measurements were obtained in a full duplex slot or with other split panel operations.

At stage 1404, the method includes determining a duplex mode configuration associated with the position information. The BS 1102 is a means for determining the duplex mode operation. The BS 1102 may parse or otherwise obtain data from the PRS measurement message 1124 indicating that the PRS measurements were obtained in a full duplex slot. For example, the PRS measurement message 1124 may include a beam ID and/or timing information associated with a half or full duplex slot. In an example, the PRS measurement message 1124 may include optional slot information indicating that the DL PRS measurement overlapped with an UL transmission. In an example, the UE 1104 may be configured to generate a bitmap with the same length of the DL PRS transmission in the time domain, where each bit indicates whether there was an overlap with an UL symbol or not. The bitmap may be included in the PRS measurement message 1124. In another example, the UE 1104 may report that an overlap existed at some point during the DL PRS transmission with a flag (e.g., one bit) in the PRS measurement message 1124.

At stage 1406, the method includes providing the position information and an indication of the duplex mode configuration to a server. The BS 1102 is a means for providing the position information and the indication to a server. The BS 1102 may provide received PRS measurement information, and an additional field, bit, or other information element (IE) to a networked server such as an LMF or an AMF. The additional IE may be configured to indicate to the server that the PRS measurement information is based on a DL PRS measurement the UE 1104 obtained in a full duplex slot. In an example, the PRS measurement information (including any slot information) and the additional IE may be included in an LPP or NPP message (e.g., inside a 5G NAS message).

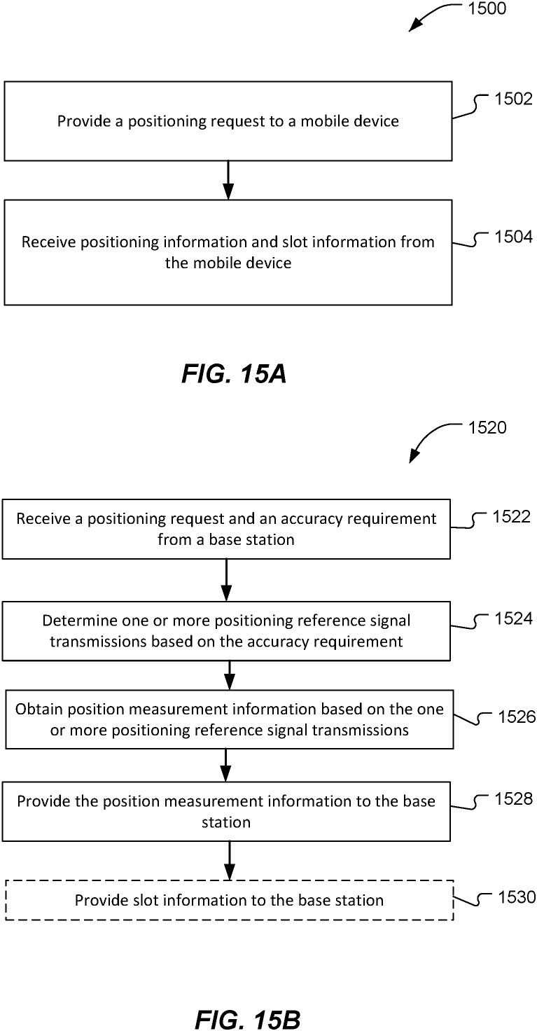

Referring to FIG. 15A, with further reference to FIG. 11B, a method 1500 for receiving position information from a mobile device includes the stages shown. The method 1500 is, however, an example only and not limiting. The method 1500 may be altered, e.g., by having stages added, removed, rearranged, combined, performed concurrently, and/or having single stages split into multiple stages.

At stage 1502, the method includes providing a positioning request to a mobile device. The BS 1102 is a means for providing the positioning request. The BS 1102 may be configured to send an LPP or NPP message to the UE 1104. For example, a positioning request with accuracy requirement message 1120 may instruct the UE 1104 to obtain one or more measurement quantities (e.g., beam ID, beam width, mean angle, RSTD, RSRP, RSRQ measurements, slot duplex configuration) of DL PRS transmitted within particular cells supported by one or more base stations (e.g., BS 1102, BSs 110a-c, etc). The positioning request with accuracy requirement message 1120 may include an indication of an accuracy requirement. The accuracy requirement may allow or preclude the use of DL PRS in a full duplex slot. In an example, the accuracy requirement may allow the use of DL PRS in full duplex slots provided there is a sufficient guard band to reduce the inaccuracies due to self-interference.

At stage 1504, the method includes receiving positioning information and slot information from the mobile device. The BS 1102 is a means for receiving the position information. The UE 1104 may be configured to provide positioning information such as PRS measurements to the BS 1102 in a PRS measurements message 1124. For example, the UE 1104 may send the measurement quantities to the BS 1102 in an LPP or NPP message (e.g., inside a 5G NAS message). In an example, the UE 1104 may be configured to compute a position estimate based on PRS measurements and the positioning information may be the estimated position computed by the UE. The UE 1104 may provide optional slot information if the PRS measurements were obtained from DL PRS transmissions that overlapped with an active UL transmission from the UE 1104. The slot information may be a bit map with the same length of the PRS in the time domain, or a single bit (or other flag variable) to indicate that there was an overlap.

Referring to FIG. 15B, with further reference to FIG. 11B, a method 1520 for providing position information to a base station includes the stages shown. The method 1520 is, however, an example only and not limiting. The method 1520 may be altered, e.g., by having stages added, removed, rearranged, combined, performed concurrently, and/or having single stages split into multiple stages. For example, stage 1530 is optional because slot information may not be required if the DL and UL transmissions do not overlap.

At stage 1522, the method includes receiving a positioning request and accuracy requirement from a base station. The UE 1104 is a means for receiving the positioning request. The UE 1104 may receive a positioning request with accuracy requirement message 1120 in an LPP and NPP message sent from the BS 1102. In an example, the positioning request may include assistance data to enable the UE 1104 to obtain one or more measurement quantities (e.g., beam ID, beam width, mean angle, RSTD, RSRP, RSRQ measurements, slot duplex configuration) of DL PRS transmitted within particular cells supported by one or more base stations (e.g., BS 1102, BSs 110a-c, etc). The accuracy requirement may be based on application requirements associated with the positioning request. For example, a high accuracy may apply when a specific location is requested (e.g., within 200 m), a mid-level accuracy may apply when an approximate location is requested (e.g., within 1000 m), and a low-level accuracy may apply when a general location is requested (e.g., within 2000 m). The accuracy requirements are examples only and not limitations as the specific distance may change based on the capabilities of a communication network.

At stage 1524, the method includes determining one or more positioning reference signal transmissions based on the accuracy requirements. The UE 1104 is a means for determining the positioning reference signal transmissions. The first DL PRS transmission 902, the second DL PRS transmission 904, the third DL PRS transmission 906, the first DL PRS transmission 1012, and the second DL PRS transmission 1008 are examples of positioning reference signal transmissions. A high accuracy requirement may preclude the use of DL PRS transmissions in a full duplex slot because a specific location of the UE 1104 may not be realized based on the beam width increase and self-interference associated with full duplex operations. A mid-level accuracy requirement may be based on DL PRS transmissions in a full duplex slot provided there is sufficient frequency separations (e.g., guard band) between the DL and UL BWPs in the full duplex slot. The frequency separation may reduce the self-interference and improve the accuracy of the position estimate. A low-level accuracy requirement may be based on a DL PRS transmission in a full duplex slot regardless of the size of a guard band. For example, an in-band full duplex slot may include overlapping DL and UL transmissions. The UE 1104 may be configured to utilize a half duplex or full duplex slots based on the accuracy requirement to obtain position measurements. In an example, the assistance data in the positioning request may include an indication of the slot the UE 1104 will utilize to obtain the position measurements.

At stage 1526, the method includes obtaining position measurement information based on the one or more positioning reference signal transmissions. The UE 1104 is a means for obtaining the position measurement information. UE 1104 is configured to perform PRS measurements using the positioning reference slot determined at stage 1524. The position measurements may include RSSI, RTT, AOA, AOD, TOA, RSTD, RSRQ and/or RSRQ information based on signals from the BS 1102 and neighboring stations.

At stage 1528, the method includes providing the position measurement information to the base station. The UE 1104 is a means for providing the position measurement information. The UE 1104 may be configured to provide the PRS measurements obtained at stage 1526 back to the communications network via the BS 1102 in a PRS measurements message 1124. For example, the UE 1104 may send the measurement quantities in an LPP or NPP message (e.g., inside a 5G NAS message). In an example, the UE 1104 may be configured to report that the PRS measurements were obtained using full duplex or other split panel operation. In an example, the UE 1104 may be configured to compute a position estimate based on PRS measurements and provide the estimated position in the PRS measurement message 1124.

At stage 1530, the method may optionally include providing slot information to the base station. The UE 1104 is a means for providing the slot information. The UE 1104 may provide slot information in the PRS measurement message 1124 to inform the BS 1102, and an associated communication network, that the PRS measurements were obtained from DL PRS transmissions that were overlapped with an active UL transmission from the UE 1104. The slot information may be in the form of a bit map of the same length of the PRS in the time domain. Each bit may show whether there was an overlap with an UL symbol or not. The slot information may be a single bit (or other flag variable) to which indicate whether there was an overlap or not. The single bit may be used to reduce the signaling overhead. The slot information may be excluded from the PRS measurement message 1124 if the active UL transmission had a sufficient frequency gap (e.g., guard band) with the DL PRS transmission.

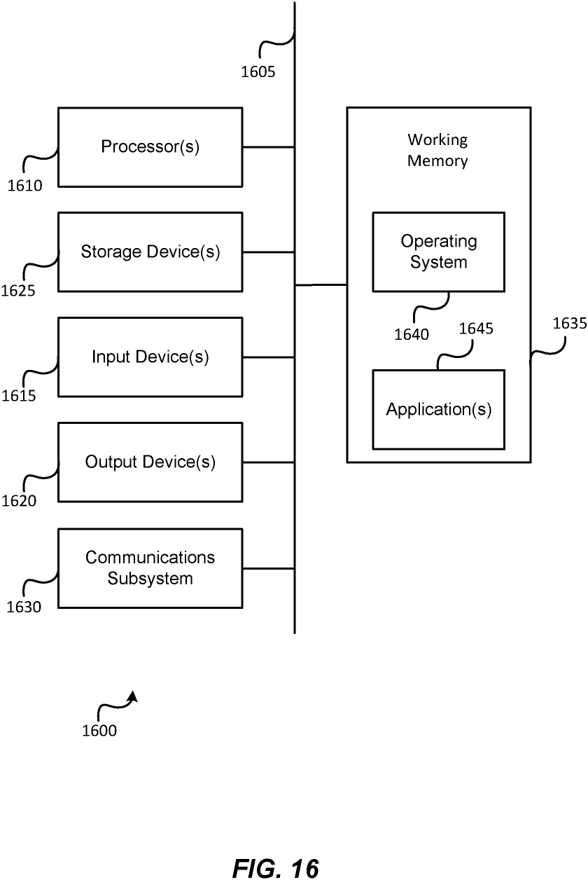

A computer system as illustrated in FIG. 16 may incorporate as part of the previously described computerized devices such as the BSs 110, 1102, UEs 120, 1104 and network controller 130. A computer system 1600 may be configured to perform the methods provided by various other embodiments, as described herein, and/or can function as a networked server, a mobile device, and/or a computer system. It should be noted that FIG. 16 is meant only to provide a generalized illustration of various components, any or all of which may be utilized as appropriate. FIG. 16, therefore, broadly illustrates how individual system elements may be implemented in a relatively separated or relatively more integrated manner.

The computer system 1600 is shown comprising hardware elements that can be electrically coupled via a bus 1605 (or may otherwise be in communication, as appropriate). The hardware elements may include one or more processors 1610, including without limitation one or more general-purpose processors and/or one or more special-purpose processors (such as digital signal processing chips, graphics acceleration processors, and/or the like); one or more input devices 1615, which can include without limitation a mouse, a keyboard and/or the like; and one or more output devices 1620, which can include without limitation a display device, a printer and/or the like.

The computer system 1600 may further include (and/or be in communication with) one or more non-transitory storage devices 1625, which can comprise, without limitation, local and/or network accessible storage, and/or can include, without limitation, a disk drive, a drive array, an optical storage device, solid-state storage devices such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1600 might also include a communications subsystem 1630, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 1630 may permit data to be exchanged with a network, other computer systems, and/or any other devices described herein. In many embodiments, the computer system 1600 will further comprise a working memory 1635, which can include a RAM or ROM device, as described above.

The computer system 1600 also can comprise software elements, shown as being currently located within the working memory 1635, including an operating system 1640, device drivers, executable libraries, and/or other code, such as one or more application programs 1645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1625 described above. In some cases, the storage medium might be incorporated within a computer system, such as the system 1600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1600 and/or might take the form of source and/or installable code, which, upon compilation and/or installation on the computer system 1600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1600) to perform methods in accordance with various embodiments of the invention. According to a set of embodiments, some or all of the procedures of such methods are performed by the computer system 1600 in response to processor 1610 executing one or more sequences of one or more instructions (which might be incorporated into the operating system 1640 and/or other code, such as an application program 1645) contained in the working memory 1635. Such instructions may be read into the working memory 1635 from another computer-readable medium, such as one or more of the storage device(s) 1625. Merely by way of example, execution of the sequences of instructions contained in the working memory 1635 might cause the processor(s) 1610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1600, various computer-readable media might be involved in providing instructions/code to processor(s) 1610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1625. Volatile media include, without limitation, dynamic memory, such as the working memory 1635. Transmission media include, without limitation, coaxial cables, copper wire and fiber optics, including the wires that comprise the bus 1605, as well as the various components of the communication subsystem 1630 (and/or the media by which the communications subsystem 1630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1600. These signals, which might be in the form of electromagnetic signals, acoustic signals, optical signals and/or the like, are all examples of carrier waves on which instructions can be encoded, in accordance with various embodiments of the invention.

The communications subsystem 1630 (and/or components thereof) generally will receive the signals, and the bus 1605 then might carry the signals (and/or the data, instructions, etc. carried by the signals) to the working memory 1635, from which the processor(s) 1605 retrieves and executes the instructions. The instructions received by the working memory 1635 may optionally be stored on a storage device 1625 either before or after execution by the processor(s) 1610.

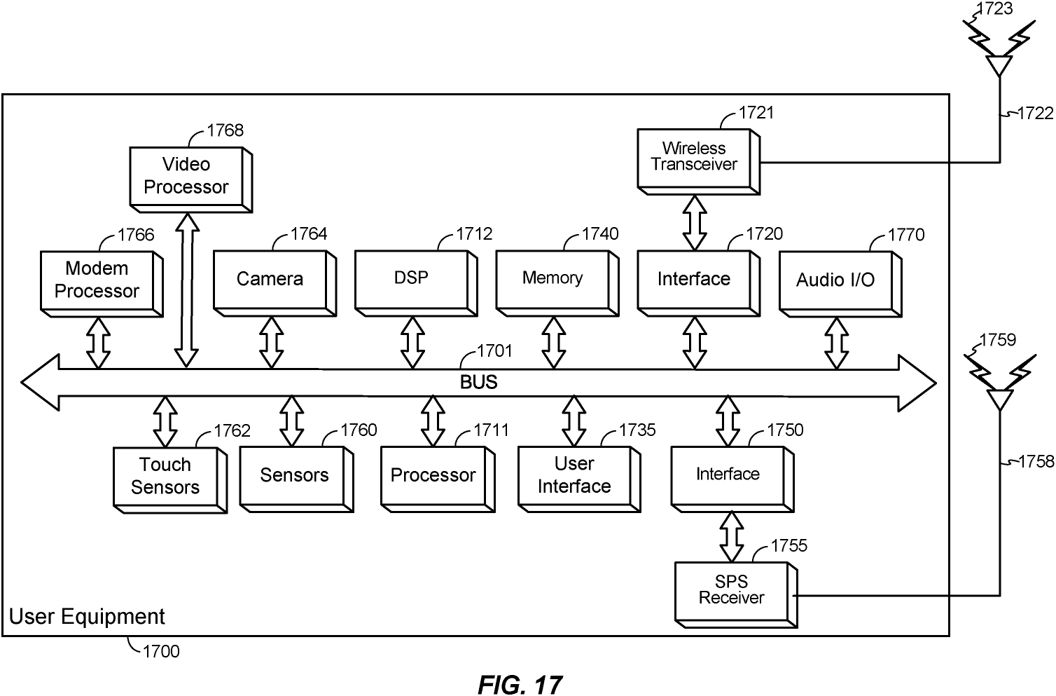

Referring to FIG. 17, a schematic diagram of a mobile device 1700 according to an embodiment is shown. The UE 120 as shown in FIG. 1 and the UE 1104 shown in FIG. 11 may comprise one or more features of the mobile device 1700 shown in FIG. 17. In certain embodiments, the mobile device 1700 may comprise a wireless transceiver 1721 which is capable of transmitting and receiving wireless signals 1723 via a wireless antenna 1722 over a wireless communication network. The wireless transceiver 1721 and the wireless antenna 1722 may include a plurality of transceivers and antennas, and may be configured for full duplex operation. A wireless transceiver 1721 may be connected to a bus 1701 by a wireless transceiver bus interface 1720. The wireless transceiver bus interface 1720 may, in some embodiments, be at least partially integrated with the wireless transceiver 1721. Some embodiments may include multiple wireless transceivers 1721 and wireless antennas 1722 to enable transmitting and/or receiving signals in full or half duplex modes according to corresponding multiple wireless communication standards such as, for example, versions of IEEE Standard 802.11, CDMA, WCDMA, LTE, UMTS, GSM, AMPS, Zigbee, Bluetooth®, and a 5G or NR radio interface defined by 3GPP, just to name a few examples. In a particular implementation, the wireless transceiver 1721 may receive and acquire a downlink signal comprising a terrestrial positioning signal such as a DL PRS. For example, the wireless transceiver 1721 may process an acquired terrestrial positioning signal sufficiently to enable detection of timing of the acquired terrestrial positioning signal.

The mobile device 1700 may comprise an SPS receiver 1755 capable of receiving and acquiring SPS signals 1759 via an SPS antenna 1752 (which may be the same as the antenna 1722 in some embodiments). The SPS receiver 1755 may process, in whole or in part, the acquired SPS signals 1759 for estimating a location of the mobile device 1700. One or more general-purpose processor(s) 1711, a memory 1740, one or more digital signal processor(s) (DSP(s)) 1712, and/or specialized processors (not shown) may be utilized to process acquired SPS signals, in whole or in part, and/or to calculate an estimated location of the mobile device 1700, in conjunction with the SPS receiver 1755. Storage of SPS, TPS or other signals (e.g., signals acquired from the wireless transceiver 1721) or storage of measurements of these signals for use in performing positioning operations may be performed in the memory 1740 or registers (not shown). The general-purpose processor(s) 1711, the memory 1740, the DSP(s) 1712, and/or specialized processors may provide or support a location engine for use in processing measurements to estimate a location of the mobile device 1700. For example, the general-purpose processor(s) 1711 or the DSP(s) 1712 may process a downlink signal acquired by the wireless transceiver 1721 to, for example, make measurements of RSSI, RTT, AOA, TOA, RSTD, RSRQ and/or RSRQ.

Also shown in FIG. 17, the DSP(s) 1712 and the general-purpose processor(s) 1711 may be connected to the memory 1740 through bus the 1701. A particular bus interface (not shown) may be integrated with the DSP(s) 1712, the general-purpose processor(s) 1711, and the memory 1740. In various embodiments, functions may be performed in response to execution of one or more machine-readable instructions stored in the memory 1740 such as on a computer-readable storage medium, such as RAM, ROM, FLASH, or disc drive, just to name a few examples. The one or more instructions may be executable by the general-purpose processor(s) 1711, specialized processors, or the DSP(s) 1712. The memory 1740 may comprise a non-transitory, processor-readable memory and/or a computer-readable memory that stores software code (programming code, instructions, etc.) that are executable by the processor(s) 1711 and/or the DSP(s) 1712 to perform functions described herein.

Also shown in FIG. 17, a user interface 1735 may comprise any one of several devices such as, for example, a speaker, microphone, display device, vibration device, keyboard, touch screen, just to name a few examples. In a particular implementation, the user interface 1735 may enable a user to interact with one or more applications hosted on the mobile device 1700. For example, devices of the user interface 1735 may store analog and/or digital signals on the memory 1740 to be further processed by the DSP(s) 1712 or the general purpose processor 1711 in response to action from a user. Similarly, applications hosted on the mobile device 1700 may store analog or digital signals on the memory 1740 to present an output signal to a user. The mobile device 1700 may optionally include a dedicated audio input/output (I/O) device 1770 comprising, for example, a dedicated speaker, microphone, digital to analog circuitry, analog to digital circuitry, amplifiers and/or gain control. This is merely an example of how an audio I/O may be implemented in a mobile device, and claimed subject matter is not limited in this respect. The mobile device 1700 may comprise touch sensors 1762 responsive to touching or pressure on a keyboard or touch screen device.

The mobile device 1700 may comprise a dedicated camera device 1764 for capturing still or moving imagery. The camera device 1764 may comprise, for example, an imaging sensor (e.g., charge coupled device or CMOS imager), lens, analog-to-digital circuitry, frame buffers, just to name a few examples. Additional processing, conditioning, encoding, and/or compression of signals representing captured images may be performed at the general purpose/application processor 1711 and/or the DSP(s) 1712. A dedicated video processor 1762 may perform conditioning, encoding, compression or manipulation of signals representing captured images. A video processor 1768 may decode/decompress stored image data for presentation on a display device (not shown) on the mobile device 1700.

The mobile device 1700 may also comprise sensors 1760 coupled to the bus 1701 which may include, for example, inertial sensors and environment sensors. Inertial sensors of the sensors 1760 may comprise, for example, accelerometers (e.g., collectively responding to acceleration of the mobile device 1700 in three dimensions), one or more gyroscopes or one or more magnetometers (e.g., to support one or more compass applications). Environment sensors of the mobile device 1700 may comprise, for example, temperature sensors, barometric pressure sensors, ambient light sensors, camera imagers, microphones, just to name few examples. The sensors 1760 may generate analog and/or digital signals that may be stored in the memory 1740 and processed by the DPS(s) 1712 or the general purpose application processor 1711 in support of one or more applications such as, for example, applications directed to positioning or navigation operations.

The mobile device 1700 may comprise a dedicated modem processor 1766 capable of performing baseband processing of signals received and downconverted at the wireless transceiver 1721 or the SPS receiver 1755. The modem processor 1766 may perform baseband processing of signals to be upconverted for transmission by the wireless transceiver 1721. In alternative implementations, instead of having a dedicated modem processor, baseband processing may be performed by a general purpose processor or DSP (e.g., the general purpose/application processor 1711 or the DSP(s) 1712). These are merely examples of structures that may perform baseband processing, and claimed subject matter is not limited in this respect.

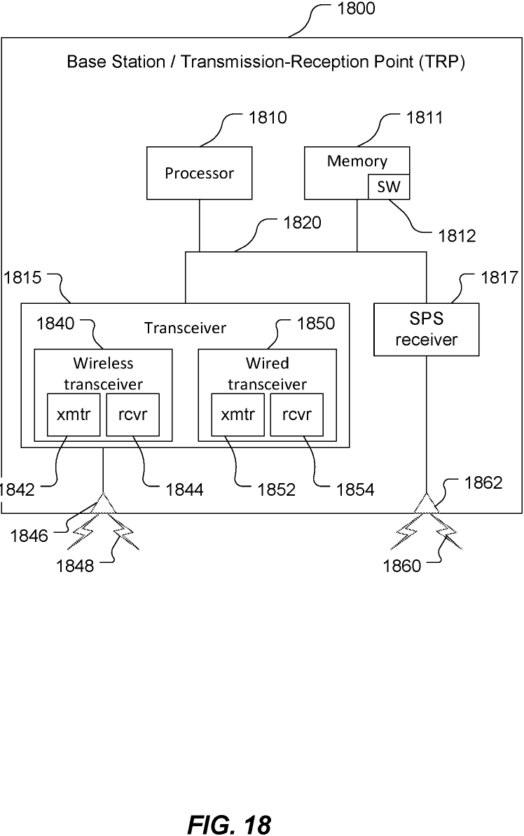

Referring also to FIG. 18, an example of a TRP 1800 of the BSs 110a-c comprises a computing platform including a processor 1810, memory 1811 including software (SW) 1812, a transceiver 1815, and (optionally) an SPS receiver 1817. The processor 1810, the memory 1811, the transceiver 1815, and the SPS receiver 1817 may be communicatively coupled to each other by a bus 1820 (which may be configured, e.g., for optical and/or electrical communication). One or more of the shown apparatus (e.g., a wireless interface and/or the SPS receiver 1817) may be omitted from the TRP 1800. The SPS receiver 1817 may be configured similarly to the SPS receiver 1717 to be capable of receiving and acquiring SPS signals 1860 via an SPS antenna 1862. The processor 1810 may include one or more intelligent hardware devices, e.g., a central processing unit (CPU), a microcontroller, an application specific integrated circuit (ASIC), etc. The processor 1810 may comprise multiple processors (e.g., including a general-purpose/ application processor, a DSP, a modem processor, a video processor, and/or a sensor processor as shown in FIG. 4). The memory 1811 is a non-transitory storage medium that may include random access memory (RAM)), flash memory, disc memory, and/or read-only memory (ROM), etc. The memory 1811 stores the software 1812 which may be processor-readable, processor-executable software code containing instructions that are configured to, when executed, cause the processor 1810 to perform various functions described herein. Alternatively, the software 1812 may not be directly executable by the processor 1810 but may be configured to cause the processor 1810, e.g., when compiled and executed, to perform the functions. The description may refer only to the processor 1810 performing a function, but this includes other implementations such as where the processor 1810 executes software and/or firmware. The description may refer to the processor 1810 performing a function as shorthand for one or more of the processors contained in the processor 1810 performing the function. The description may refer to the TRP 1800 performing a function as shorthand for one or more appropriate components of the TRP 1800 (and thus of one of the BSs 110a-c) performing the function. The processor 1810 may include a memory with stored instructions in addition to and/or instead of the memory 1811. Functionality of the processor 1810 is discussed more fully below.

The transceiver 1815 may include a wireless transceiver 1840 and a wired transceiver 1850 configured to communicate with other devices through wireless connections and wired connections, respectively. For example, the wireless transceiver 1840 may include a transmitter 1842 and receiver 1844 coupled to one or more antennas 1846 for transmitting (e.g., on one or more uplink channels) and/or receiving (e.g., on one or more downlink channels) wireless signals 1848 and transducing signals from the wireless signals 1848 to wired (e.g., electrical and/or optical) signals and from wired (e.g., electrical and/or optical) signals to the wireless signals 1848. Thus, the transmitter 1842 may include multiple transmitters that may be discrete components or combined/integrated components, and/or the receiver 1844 may include multiple receivers that may be discrete components or combined/integrated components. The wireless transceiver 1840 may be configured to communicate signals (e.g., with the UE 1104, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 1850 may include a transmitter 1852 and a receiver 1854 configured for wired communication, e.g., with the network controller 130 to send communications to, and receive communications from, the network controller 130, for example. The transmitter 1852 may include multiple transmitters that may be discrete components or combined/integrated components, and/or the receiver 1854 may include multiple receivers that may be discrete components or combined/integrated components. The wired transceiver 1850 may be configured, e.g., for optical communication and/or electrical communication.

The configuration of the TRP 1800 shown in FIG. 18 is an example and not limiting of the invention, including the claims, and other configurations may be used. For example, the description herein discusses that the TRP 1800 is configured to perform or performs several functions, but one or more of these functions may be performed by the computer 1600 and/or the UE 1104 (i.e., the UE 1104 may be configured to perform one or more of these functions).

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

Implementation examples are described in the following numbered clauses:
1. A method of providing positioning information for a mobile device to a base station, comprising:
   receiving, at the mobile device, a positioning request and an accuracy requirement from the base station;
   determining one or more positioning reference signal transmissions based on the accuracy requirement;
   obtaining position measurement information based on the one or more positioning reference signal transmissions; and
   providing the position measurement information to the base station.
2. The method of clause 1 wherein one of the one or more positioning reference signal transmissions is a half duplex slot.
3. The method of clause 1 wherein one of the one or more positioning reference signal transmissions is a full duplex slot.
4. The method of clause 1 wherein the position measurement information includes reference signal time difference measurements.
5. The method of clause 1 wherein the position measurement information includes RSSI or RTT measurements.
6. The method of clause 1 wherein a downlink positioning measurement is obtained by the mobile device concurrently with an uplink transmission from the mobile device.
7. The method of clause 6 wherein one or more symbols of the downlink positioning measurement overlap with one or more symbols of the uplink transmission.
8. The method of clause 7 further comprising providing slot information to the base station based on an overlap of the one or more symbols of the downlink positioning measurement and the one or more symbols of the uplink transmission.
9. The method of clause 8 wherein the slot information comprises a bit map based on the one or more symbols in the overlap.
10. The method of clause 8 wherein the slot information comprises a flag variable or a single bit to indicate a presence of the overlap.
11. A method of providing position information for a mobile device to a server, comprising:
   determining position information for the mobile device;
   determining a duplex mode configuration associated with the position information; and
   providing the position information and an indication of the duplex mode configuration to the server.
12. The method of clause 11 wherein determining the position information includes receiving the position information from the mobile device in a wireless signal.
13. The method of clause 11 wherein determining the duplex mode configuration includes receiving the indication of the duplex mode configuration from the mobile device in a wireless signal.
14. The method of clause 13 wherein the indication of the duplex mode configuration includes a beam identification value.
15. The method of clause 13 wherein the indication of the duplex mode configuration includes slot information indicating that a downlink positioning measurement was obtained by the mobile device concurrently with an uplink transmission from the mobile device.
16. The method of clause 15 wherein one or more symbols of the downlink positioning measurement overlap with one or more symbols of the uplink transmission.
17. The method of clause 16 wherein the slot information is based on an overlap of the one or more symbols of the downlink positioning measurement and the one or more symbols of the uplink transmission.
18. The method of clause 17 wherein the slot information comprises a bit map based on the one or more symbols in the overlap.
19. The method of clause 17 wherein the slot information comprises a flag variable or a single bit to indicate a presence of the overlap.
20. The method of clause 11 wherein providing the indication of the duplex mode configuration includes indicating the position information was obtained in a full duplex slot.
21. The method of clause 11 wherein providing the indication of the duplex mode configuration includes indicating the position information was obtained from a base station operating in a split panel mode.
22. A method for providing a positioning reference signal muting pattern, comprising:
   determining a full duplex scheme including a plurality of full duplex slots;
   determining the positioning reference signal muting pattern based at least in part on the plurality of full duplex slots; and
   providing the positioning reference signal muting pattern to a mobile device.
23. The method of clause 22 wherein the positioning reference signal muting pattern is configured to mute positioning reference signals of the plurality of full duplex slots in the full duplex scheme.
24. The method of clause 22 wherein the positioning reference signal muting pattern is configured to mute positioning reference signals in one or more in-band full duplex slots in the full duplex scheme, wherein the one or more in-band full duplex slots allow simultaneous uplink and downlink transmission without a guard band.
25. The method of clause 22 wherein the positioning reference signal muting pattern is configured to mute positioning reference signals in one or more sub-band full duplex slots in the full duplex scheme, wherein the one or more sub-band full duplex slots allow simultaneous uplink and downlink transmission with a frequency separation that is insufficient to reduce self-interference on the mobile device.
26. The method of clause 22 wherein the positioning reference signal muting pattern excludes positioning reference signals in one or more sub-band full duplex slots in the full duplex scheme, wherein the one or more sub-band full duplex slots allow simultaneous uplink and downlink transmission with a frequency separation that is sufficient to reduce self-interference on the mobile device.
27. An apparatus, comprising:
   a memory;
   one or more transceivers;
   a processor communicatively coupled to the memory and the one or more transceivers and configured to:
   receive, via the one or more transceivers, a positioning request and an accuracy requirement from a base station;
   determine one or more positioning reference signal transmissions based on the accuracy requirement;
   obtain position measurement information based on the one or more positioning reference signal transmissions; and
   provide the position measurement information to the base station.
28. The apparatus of clause 27 wherein one of the one or more positioning reference signal transmissions is a half duplex slot.
29. The apparatus of clause 27 wherein one of the one or more positioning reference signal transmissions is a full duplex slot.
30. The apparatus of clause 27 wherein the position measurement information includes reference signal time difference measurements.
31. The apparatus of clause 27 wherein the position measurement information includes RSSI or RTT measurements.
32. The apparatus of clause 27 wherein a downlink positioning measurement is obtained with the one or more transceivers concurrently with an uplink transmission with the one or more transceivers.
33. The apparatus of clause 32 wherein one or more symbols of the downlink positioning measurement overlap with one or more symbols of the uplink transmission.
34. The apparatus of clause 33 further comprising providing slot information to the base station based on an overlap of the one or more symbols of the downlink positioning measurement and the one or more symbols of the uplink transmission.
35. The apparatus of clause 34 wherein the slot information comprises a bit map based on the one or more symbols in the overlap.
36. The apparatus of clause 34 wherein the slot information comprises a flag variable or a single bit to indicate a presence of the overlap.
37. An apparatus, comprising:
   a memory;
   a processor communicatively coupled to the memory and configured to:
   determine position information for a mobile device;
   determine a duplex mode configuration associated with the position information; and
   provide the position information and an indication of the duplex mode configuration to a server.
38. The apparatus of clause 37 wherein the indication of the duplex mode configuration includes a beam identification value.
39. The apparatus of clause 37 wherein the indication of the duplex mode configuration includes slot information indicating that a downlink positioning measurement was obtained by the mobile device concurrently with an uplink transmission from the mobile device.
40. The apparatus of clause 39 wherein one or more symbols of the downlink positioning measurement overlap with one or more symbols of the uplink transmission.
41. The apparatus of clause 40 wherein the slot information is based on an overlap of the one or more symbols of the downlink positioning measurement and the one or more symbols of the uplink transmission.
42. The apparatus of clause 41 wherein the slot information comprises a bit map based on the one or more symbols in the overlap.
43. The apparatus of clause 41 wherein the slot information comprises a flag variable or a single bit to indicate a presence of the overlap.
44. The apparatus of clause 37 wherein the processor is configured to provide an indication that the position information was obtained in a full duplex slot.
45. The apparatus of clause 37 wherein the processor is configured to provide an indication that the position information was obtained from a base station operating in a split panel mode.
46. An apparatus, comprising:
   a memory;
   a transceiver;
   a processor communicatively coupled to the memory and the transceiver and configured to:
   determine a full duplex scheme including a plurality of full duplex slots;
   determine a positioning reference signal muting pattern based at least in part on the plurality of full duplex slots; and
   provide the positioning reference signal muting pattern to a mobile device.
47. The apparatus of clause 46 wherein the positioning reference signal muting pattern is configured to mute positioning reference signals of the plurality of full duplex slots in the full duplex scheme.
48. The apparatus of clause 46 wherein the positioning reference signal muting pattern is configured to mute positioning reference signals in one or more in-band full duplex slots in the full duplex scheme, wherein the one or more in-band full duplex slots allow simultaneous uplink and downlink transmission without a guard band.
49. The apparatus of clause 46 wherein the positioning reference signal muting pattern is configured to mute positioning reference signals in one or more sub-band full duplex slots in the full duplex scheme, wherein the one or more sub-band full duplex slots allow simultaneous uplink and downlink transmission with a frequency separation that is insufficient to reduce self-interference on the mobile device.
50. The apparatus of clause 46 wherein the positioning reference signal muting pattern excludes positioning reference signals in one or more sub-band full duplex slots in the full duplex scheme, wherein the one or more sub-band full duplex slots allow simultaneous uplink and downlink transmission with a frequency separation that is sufficient to reduce self-interference on the mobile device.
51. An apparatus for providing positioning information for a mobile device to a base station, comprising:
   means for receiving a positioning request and an accuracy requirement from the base station;
   means for determining one or more positioning reference signal transmissions based on the accuracy requirement;
   means for obtaining position measurement information based on the one or more positioning reference signal transmissions; and
   means for providing the position measurement information to the base station.
52. A non-transitory processor-readable storage medium comprising processor-readable instructions configured to cause one or more processors to provide positioning information for a mobile device to a base station, comprising:
   code for receiving a positioning request and an accuracy requirement from the base station;
   code for determining one or more positioning reference signal transmissions based on the accuracy requirement;
   code for obtaining position measurement information based on the one or more positioning reference signal transmissions; and
   code for providing the position measurement information to the base station.
53. An apparatus for providing position information for a mobile device to a server, comprising:
   means for determining position information for the mobile device;
   means for determining a duplex mode configuration associated with the position information; and
   means for providing the position information and an indication of the duplex mode configuration to the server.
54. A non-transitory processor-readable storage medium comprising processor-readable instructions configured to cause one or more processors to provide position information for a mobile device to a server, comprising:
   code for determining position information for the mobile device;
   code for determining a duplex mode configuration associated with the position information; and
   code for providing the position information and an indication of the duplex mode configuration to the server.
55. An apparatus for providing a positioning reference signal muting pattern, comprising:
   means for determining a full duplex scheme including a plurality of full duplex slots;
   means for determining a positioning reference signal muting configuration based at least in part on the plurality of full duplex slots; and
   means for providing the positioning reference signal muting configuration to a mobile device.
56. A non-transitory processor-readable storage medium comprising processor-readable instructions configured to cause one or more processors to provide a positioning reference signal muting pattern, comprising:
   code for determining a full duplex scheme including a plurality of full duplex slots;
   code for determining a positioning reference signal muting configuration based at least in part on the plurality of full duplex slots; and
   code for providing the positioning reference signal muting configuration to a mobile device.

What is claimed is:

1. A method of providing positioning information for a mobile device to a base station, comprising:
receiving, at the mobile device, a positioning request and an accuracy requirement from the base station;
determining one or more positioning reference signal transmissions based on the accuracy requirement;
obtaining position measurement information based on the one or more positioning reference signal transmissions; and
providing the position measurement information to the base station.

2. The method of claim 1 wherein one of the one or more positioning reference signal transmissions is a half duplex slot.

3. The method of claim 1 wherein one of the one or more positioning reference signal transmissions is a full duplex slot.

4. The method of claim 1 wherein the position measurement information includes reference signal time difference measurements.

5. The method of claim 1 wherein the position measurement information includes RSSI or RTT measurements.

6. The method of claim 1 wherein a downlink positioning measurement is obtained by the mobile device concurrently with an uplink transmission from the mobile device.

7. The method of claim 6 wherein one or more symbols of the downlink positioning measurement overlap with one or more symbols of the uplink transmission.

8. The method of claim 7 further comprising providing slot information to the base station based on an overlap of the one or more symbols of the downlink positioning measurement and the one or more symbols of the uplink transmission.

9. The method of claim 8 wherein the slot information comprises a bit map based on the one or more symbols in the overlap.

10. The method of claim 8 wherein the slot information comprises a flag variable or a single bit to indicate a presence of the overlap.

11. A method of providing position information for a mobile device to a server, comprising:
determining position information for the mobile device;
determining a duplex mode configuration associated with the position information; and
providing the position information and an indication of the duplex mode configuration to the server.

12. The method of claim 11 wherein determining the position information includes receiving the position information from the mobile device in a wireless signal.

13. The method of claim 11 wherein determining the duplex mode configuration includes receiving the indication of the duplex mode configuration from the mobile device in a wireless signal.

14. The method of claim 13 wherein the indication of the duplex mode configuration includes a beam identification value.

15. The method of claim 13 wherein the indication of the duplex mode configuration includes slot information indicating that a downlink positioning measurement was obtained by the mobile device concurrently with an uplink transmission from the mobile device.

16. The method of claim 15 wherein one or more symbols of the downlink positioning measurement overlap with one or more symbols of the uplink transmission.

17. The method of claim 16 wherein the slot information is based on an overlap of the one or more symbols of the downlink positioning measurement and the one or more symbols of the uplink transmission.

18. The method of claim 17 wherein the slot information comprises a bit map based on the one or more symbols in the overlap.

19. The method of claim 17 wherein the slot information comprises a flag variable or a single bit to indicate a presence of the overlap.

20. The method of claim 11 wherein providing the indication of the duplex mode configuration includes indicating the position information was obtained in a full duplex slot.

21. The method of claim 11 wherein providing the indication of the duplex mode configuration includes indicating the position information was obtained from a base station operating in a split panel mode.

22. A method for providing a positioning reference signal muting pattern, comprising:
determining a full duplex scheme including a plurality of full duplex slots;
determining the positioning reference signal muting pattern based at least in part on the plurality of full duplex slots; and
providing the positioning reference signal muting pattern to a mobile device.

23. The method of claim 22 wherein the positioning reference signal muting pattern is configured to mute positioning reference signals of the plurality of full duplex slots in the full duplex scheme.

24. The method of claim 22 wherein the positioning reference signal muting pattern is configured to mute positioning reference signals in one or more in-band full duplex slots in the full duplex scheme, wherein the one or more in-band full duplex slots allow simultaneous uplink and downlink transmission without a guard band.

25. The method of claim 22 wherein the positioning reference signal muting pattern is configured to mute positioning reference signals in one or more sub-band full duplex slots in the full duplex scheme, wherein the one or more sub-band full duplex slots allow simultaneous uplink and downlink transmission with a frequency separation that is insufficient to reduce self-interference on the mobile device.

26. The method of claim 22 wherein the positioning reference signal muting pattern excludes positioning reference signals in one or more sub-band full duplex slots in the full duplex scheme, wherein the one or more sub-band full duplex slots allow simultaneous uplink and downlink transmission with a frequency separation that is sufficient to reduce self-interference on the mobile device.

27. An apparatus, comprising:
a memory;
one or more transceivers;
a processor communicatively coupled to the memory and the one or more transceivers and configured to:
receive, via the one or more transceivers, a positioning request and an accuracy requirement from a base station;
determine one or more positioning reference signal transmissions based on the accuracy requirement;
obtain position measurement information based on the one or more positioning reference signal transmissions; and
provide the position measurement information to the base station.

28. The apparatus of claim 27 wherein one of the one or more positioning reference signal transmissions is a half duplex slot.

29. The apparatus of claim 27 wherein one of the one or more positioning reference signal transmissions is a full duplex slot.

30. The apparatus of claim 27 wherein the position measurement information includes reference signal time difference measurements.

31. The apparatus of claim 27 wherein the position measurement information includes RSSI or RTT measurements.

32. The apparatus of claim 27 wherein a downlink positioning measurement is obtained with the one or more transceivers concurrently with an uplink transmission with the one or more transceivers.

33. The apparatus of claim 32 wherein one or more symbols of the downlink positioning measurement overlap with one or more symbols of the uplink transmission.

34. The apparatus of claim 33 further comprising providing slot information to the base station based on an overlap of the one or more symbols of the downlink positioning measurement and the one or more symbols of the uplink transmission.

35. The apparatus of claim 34 wherein the slot information comprises a bit map based on the one or more symbols in the overlap.

36. The apparatus of claim 34 wherein the slot information comprises a flag variable or a single bit to indicate a presence of the overlap.

37. An apparatus, comprising:
a memory;
a processor communicatively coupled to the memory and configured to:
determine position information for a mobile device;
determine a duplex mode configuration associated with the position information; and
provide the position information and an indication of the duplex mode configuration to a server.

38. The apparatus of claim 37 wherein the indication of the duplex mode configuration includes a beam identification value.

39. The apparatus of claim 37 wherein the indication of the duplex mode configuration includes slot information indicating that a downlink positioning measurement was obtained by the mobile device concurrently with an uplink transmission from the mobile device.

40. The apparatus of claim 39 wherein one or more symbols of the downlink positioning measurement overlap with one or more symbols of the uplink transmission.

41. The apparatus of claim 40 wherein the slot information is based on an overlap of the one or more symbols of the downlink positioning measurement and the one or more symbols of the uplink transmission.

42. The apparatus of claim 41 wherein the slot information comprises a bit map based on the one or more symbols in the overlap.

43. The apparatus of claim 41 wherein the slot information comprises a flag variable or a single bit to indicate a presence of the overlap.

44. The apparatus of claim 37 wherein the processor is configured to provide an indication that the position information was obtained in a full duplex slot.

45. The apparatus of claim 37 wherein the processor is configured to provide an indication that the position information was obtained from a base station operating in a split panel mode.

46. An apparatus, comprising:
a memory;
a transceiver;
a processor communicatively coupled to the memory and the transceiver and configured to:
determine a full duplex scheme including a plurality of full duplex slots;
determine a positioning reference signal muting pattern based at least in part on the plurality of full duplex slots; and
provide the positioning reference signal muting pattern to a mobile device.

47. The apparatus of claim 46 wherein the positioning reference signal muting pattern is configured to mute positioning reference signals of the plurality of full duplex slots in the full duplex scheme.

48. The apparatus of claim 46 wherein the positioning reference signal muting pattern is configured to mute positioning reference signals in one or more in-band full duplex slots in the full duplex scheme, wherein the one or more in-band full duplex slots allow simultaneous uplink and downlink transmission without a guard band.

49. The apparatus of claim 46 wherein the positioning reference signal muting pattern is configured to mute positioning reference signals in one or more sub-band full duplex slots in the full duplex scheme, wherein the one or more sub-band full duplex slots allow simultaneous uplink and downlink transmission with a frequency separation that is insufficient to reduce self-interference on the mobile device.

50. The apparatus of claim 46 wherein the positioning reference signal muting pattern excludes positioning reference signals in one or more sub-band full duplex slots in the full duplex scheme, wherein the one or more sub-band full duplex slots allow simultaneous uplink and downlink transmission with a frequency separation that is sufficient to reduce self-interference on the mobile device.

51. An apparatus for providing positioning information for a mobile device to a base station, comprising:
means for receiving a positioning request and an accuracy requirement from the base station;
means for determining one or more positioning reference signal transmissions based on the accuracy requirement;
means for obtaining position measurement information based on the one or more positioning reference signal transmissions; and
means for providing the position measurement information to the base station.

52. A non-transitory processor-readable storage medium comprising processor-readable instructions configured to cause one or more processors to provide positioning information for a mobile device to a base station, comprising:
code for receiving a positioning request and an accuracy requirement from the base station;
code for determining one or more positioning reference signal transmissions based on the accuracy requirement;
code for obtaining position measurement information based on the one or more positioning reference signal transmissions; and
code for providing the position measurement information to the base station.

53. An apparatus for providing position information for a mobile device to a server, comprising:
means for determining position information for the mobile device;
means for determining a duplex mode configuration associated with the position information; and
means for providing the position information and an indication of the duplex mode configuration to the server.

54. A non-transitory processor-readable storage medium comprising processor-readable instructions configured to cause one or more processors to provide position information for a mobile device to a server, comprising:
code for determining position information for the mobile device;
code for determining a duplex mode configuration associated with the position information; and
code for providing the position information and an indication of the duplex mode configuration to the server.

55. An apparatus for providing a positioning reference signal muting pattern, comprising:
means for determining a full duplex scheme including a plurality of full duplex slots;
means for determining a positioning reference signal muting configuration based at least in part on the plurality of full duplex slots; and
means for providing the positioning reference signal muting configuration to a mobile device.

56. A non-transitory processor-readable storage medium comprising processor-readable instructions configured to cause one or more processors to provide a positioning reference signal muting pattern, comprising:
code for determining a full duplex scheme including a plurality of full duplex slots;
code for determining a positioning reference signal muting configuration based at least in part on the plurality of full duplex slots; and
code for providing the positioning reference signal muting configuration to a mobile device.
